(19) United States
(12) Patent Application Publication
(10) Pub. No.: US 2026/0038271 A1
(43) Pub. Date: Feb. 5, 2026

(54) GAS FLOW RATE FLARING FRAMEWORK

(71) Applicant: Schlumberger Technology Corporation, Sugar Land, TX (US)

(72) Inventors: Vigneshwaran Santhalingam, Houston, TX (US); Antonio Massoni Abinader, Hosuton, TX (US); Velizar Vesselinov, Houston, TX (US); Dhananjaya Krishna, Houston, TX (US)

(21) Appl. No.: 19/288,697

(22) Filed: Aug. 1, 2025

Related U.S. Application Data
(60) Provisional application No. 63/678,727, filed on Aug. 2, 2024.

(51) Int. Cl. G06V 20/52; E21B 41/00; G06V 10/26; G06V 10/766

(52) U.S. Cl. CPC G06V 20/52; E21B 41/0071; G06V 10/26; G06V 10/766

(57) ABSTRACT

A method can include receiving image data, where the image data include flare image data of a flare of a burner that burns one or more gases fed by at least one gas line; segmenting the image data to generated segmented data; and estimating a gas flow rate of at least one of the one or more gases using at least a portion of the segmented data and a machine learning model.

### RELATED APPLICATION

This application claims priority to and the benefit of a U.S. Provisional Application having Ser. No. 63/678,727, filed 2 Aug. 2024, which is incorporated by reference herein in its entirety.

### BACKGROUND

The global oil and gas industry is trending toward improved environmental safety and compliance throughout the various phases of a well lifecycle. Exploration and production involve dynamic well testing that can produce a large amount of hydrocarbons at the surface. As, at times, excess hydrocarbons cannot be stored, they may be disposed of by flaring, which can be relevant for onshore operations and offshore operations.

Combustion of hydrocarbon can result in various types of emissions, which can include, for example, visible emissions, heat energy emissions, and smoke. Burner operations (e.g., flaring) can be controlled on site, for example, via air supply adjustment, which may aim to maintain acceptable combustion through variations in fluid properties, flowrates, and weather conditions.

For the continuous burning phase which can last for days, on site monitoring and regulation of air supply to a burner can be controllable if appropriate control equipment to regulate gas flow and combustion exists on site. A failure to monitor combustion and adjust air supply according to flame or smoke appearance can have a negative impact on combustion quality and emissions from a burner. For example, consider short chain hydrocarbons such as methane, propane, ethylene, propylene, butadiene and butane, which under ideal conditions can react efficiently with atmospheric oxygen to form carbon dioxide (CO₂) and water. Inefficient combustion (e.g., poor quality combustion) can result in higher emissions of such hydrocarbons along with chemical intermediates. Inefficient combustion can result in environmental and regulatory issues. Flare monitoring can increase awareness of inefficient combustion of lit flares and may provide indications of direct emissions from unlit flares.

### SUMMARY

A method can include receiving image data, where the image data include flare image data of a flare of a burner that burns one or more gases fed by at least one gas line; segmenting the image data to generated segmented data; and estimating a gas flow rate of at least one of the one or more gases using at least a portion of the segmented data and a machine learning model. A system can include a processor; a memory accessible by the processor; and processor-executable instructions stored in the memory that are executable to instruct the system to: receive image data, where the image data include flare image data of a flare of a burner that burns one or more gases fed by at least one gas line; segment the image data to generated segmented data; and estimate a gas flow rate of at least one of the one or more gases using at least a portion of the segmented data and a machine learning model. One or more non-transitory computer-readable storage media can include computer-executable instructions executable to instruct a computer to: receive image data, where the image data include flare image data of a flare of a burner that burns one or more gases fed by at least one gas line; segment the image data to generated segmented data; and estimate a gas flow rate of at least one of the one or more gases using at least a portion of the segmented data and a machine learning model.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 is a series of diagrams of example environments and an example of a burner system.

FIG. 2 is a diagram of an example of a burner system.

FIG. 3 is a diagram of an example of a burner boom.

FIG. 4 is a diagram of an example of a burner system.

FIG. 5 is a diagram of an example of a system.

FIG. 6 is a series of example images.

FIG. 7 is an example of a plot.

FIG. 8 is an example of a table.

FIG. 9 is an example of a plot.

FIG. 10 is a diagram of an example of a system.

FIG. 11 is a diagram of an example of a computational framework.

FIG. 12 is a diagram of an example of a method and an example of a system.

FIG. 13 illustrates example components of a system and a networked system.

### DETAILED DESCRIPTION

The following description is not to be taken in a limiting sense, but rather is made merely for the purpose of describing the general principles of the implementations. The scope of the described implementations should be ascertained with reference to the issued claims.

Methane (CH₄) is a hydrocarbon that can be classified as an anthropogenic greenhouse gas (GHG) in the atmosphere (e.g., consider carbon dioxide as another type of greenhouse gas). The International Energy Agency (IEA) Methane Tracker 2020 report states that emissions from the oil and gas industry account for approximately 22 percent of anthropogenic sources (see IEA Methane Tracker, Fuel report—March 2020 https://www.iea.org/reports/methane-tracker-2020).

When natural gas is burned in a flare, CO₂ and water are generated as products of the combustion process. Considering that methane is estimated to be 80 times more potent that CO₂ in a 20-year lifespan, knowing the status of a flare (e.g., a burner) can be helpful. For example, knowing when flares are unlit and venting uncombusted methane to the atmosphere can be helpful to know for various reasons. As explained, efficient combustion by a lit flare aims to convert hydrocarbons to CO₂ and water.

Flaring in the oil and gas industry is a process where excess gases are burned off through a flare stack. This practice if performed for various reasons, including safety reasons, such as pressure relief during unplanned over-pressuring of plant equipment, and for managing gases that cannot be processed economically or otherwise in a practical manner for one or more reasons. However, flaring is also a source of GHG emissions, releasing gases such as carbon dioxide and methane into the atmosphere. Environmental impact of emissions makes it desirable to monitor and control flaring activities effectively.

In various instances, one or more flow meters may be present where such devices, which may measure rate of flow of gas being flared. However, such devices may be prohibitively expensive and complex to install, especially in remote or offshore locations. High cost and complexity can hinder comprehensive monitoring efforts, leaving a gap in effective environmental management practices.

Moreover, the practice among oil and gas operators to rotate available flow meters across different flare stacks may complicate consistent monitoring. Such an approach to rotation of equipment may result in minimal monitoring-sometimes sufficient to solely meet a bare minimum of legal reporting requirements. Such practices underscore a demand for more robust and continuous monitoring solutions.

As an example, a gas flow rate flaring framework may provide for estimating flaring emissions using relatively accessible and cost-effective technology. For example, by leveraging a system composed of a camera and an edge computer, a framework may utilize visual data and computing techniques to estimate volume of gas flared. Such an approach may reduce economic burden associated with flow meters and may enhance feasibility of continuous monitoring across various operational settings in the oil and gas domain. As an example, a framework may be effective and have implications for environmental monitoring and regulatory compliance in the industry.

In the oil and gas industry, an ability to accurately measure gas flow rates in flare stacks can benefit operational efficiency, environmental compliance, and safety. As explained, physical, in-line gas flow meters often face limitations due to harsh environmental conditions and high maintenance costs. To address such challenges, various approaches to gas flow rate estimation have been developed. For example, consider use of Computational Fluid Dynamics (CFD) simulations. These simulations model and predict gas flow rates in flare systems by creating detailed models of the purging process, considering factors such as gas velocity, temperature, and baffle size. By doing so, CFD provides a reliable estimation of flow rates without demand for gas flow meters (see, e.g., Azin et al., 2015). However, CFD simulations can be computationally intensive and demand detailed knowledge of physical properties and operating conditions, which may not always be readily available.

As another example, consider utilization of satellite sensor data to measure radiant heat and temperature. Techniques like the Nightfire algorithm (National Oceanic and Atmospheric Administration) employ satellite data to measure radiant heat emitted from flares. These measurements, when correlated with known volumes of flared gas, allow for flow rate estimation. Such an approach involves processing satellite data to filter out non-flaring sources and improve accuracy through clustering observations (see, e.g., Flaring Monitor, 2003). However, such an approach tends to rely heavily on availability and quality of satellite data, which can be affected by weather conditions and satellite coverage. Exergy and exergoeconomic analyses may offer another perspective by evaluating the thermodynamic efficiency of gas flaring processes and their economic implications. Assessing the energy potential (exergy) of flared gas enables estimates of flow rates and optimization of flare gas management strategies. Such analyses may provide valuable insights into operational efficiency and environmental impact of flare gas utilization (see, e.g., The World Bank, 2004). However, such approaches can demand extensive data collection and analysis, which can be time-consuming and resource intensive.

As an example, a gas flow rate flaring framework may implement deep learning (e.g., a machine learning technology). In such an example, the framework may exploit existing real-time visual data of a flare stack to draw a relationship between flare size and gas flow rate. As an example, a framework may include segmenting fire on a flare stack and assessing use of flare segments.

As to segmentation, in deep learning, one or more techniques for fire segmentation may be employed, which may enhance accuracy and efficiency of a fire monitoring system. As an example, consider a wildfire image segmentation approach of Wang et al., 2024, which employs a Swin Transformer-based model combined with an adaptive multi-scale attention mechanism and focal loss function, achieving precision and robustness in wildfire image segmentation. However, such models can be complex and computationally intensive, often demanding substantial pre-labeled data. Similarly, an approach of Talaat et al., 2023, proposes fire detection using YOLO-v8, which integrates deep learning with IoT. Such an approach, however, still depends on availability of high-quality labeled data and can be limited by computational resources.

As to a “You Only Look Once” (YOLO) model, YOLO may be considered to be a single-shot detector that may utilize a neural network, such as, for example, a fully convolutional neural network (CNN), to process an image. As an example, a YOLO model may apply a single neural network to an image where this network divides the image into regions and predicts bounding boxes and probabilities for each region. In such an example, the bounding boxes may be weighted by the predicted probabilities. While a single-shot approach is mentioned, a few-shot approach may be considered (e.g., consider few being less than ten samples per class, etc.). As an example, a zero-shot approach may be utilized. For example, consider the YOLO-World zero-shot model. As an example, a combination of models may be utilized, for example, consider one or more of a single-shot, a few-shot, and a zero-shot. As an example, more than one model may be utilized, which may be operated in parallel and/or in series. In parallel, results may be compared and/or leveraged to product output and, in series, consider one model being triggered based on output of another, where a follow-up model may provide for confirmation, increased accuracy, etc. As an example, an in-parallel approach and/or an in-series approach may be implemented, for example, for flare and smoke (e.g., or other relevant feature(s)).

Fire segmentation may be part of one or more fire detection and monitoring systems. As an example, a framework may include utilizing one or more computer vision (CV) and/or machine learning (ML) techniques to identify and isolate one or more fire regions in images or video feeds. Deep learning techniques, particularly Convolutional Neural Networks (CNNs) like U-Net and DeepLab, find use for fire segmentation. Such models tend to capture both local and global features of fire in images, leading to segmentation accuracy and making them particularly useful in real-time applications where quick decision-making may be relevant (see, e.g., Ronneberger et al., 2015 and Long et al., 2015). However, as explained, various models can demand large amounts of labeled training data, which can be expensive and time-consuming to obtain. As an example, one or more active learning (AL) techniques may be employed to incrementally train models, for example, by selecting the most informative samples to improve performance iteratively. In fire segmentation, AL can exhibit accuracy with fewer labeled data samples, making it efficient and cost-effective (see, e.g., Marto et al., 2023). Yet, AL still demands some amount and/or degree of labeled data, which may involve manual labeling. One or more explainable AI techniques may be applied to understand and quantify fire properties from images, aiding in segmentation and estimating fire intensity and spread (e.g., for firefighting and resource allocation) (see, e.g., Naser et al., 2020). While such techniques enhance model interpretability, they do not address an underlying demand for labeled training data. Vision Transformers, known for their ability to model long-range dependencies, have been adapted for fire segmentation tasks. For example, models like TransUNet and MedT demonstrate performance in segmenting forest fires by capturing both global and local features, which may help to reduce misclassifications. Such models may have relatively high F1-scores, indicating effectiveness in identifying and segmenting fire regions (see, e.g., Attia et al., 2021). However, similar to CNNs, such models can also demand substantial labeled data for training. Additionally, Vision Transformers demand substantial computational power, which can present a bottleneck for one or more applications. Various edge deployable computational devices tend to have limited compute capacity, which may restrict the type and size of deep-learning models that may be used for real-time applications. Where edge deployment is desirable, as an example, a framework may utilize one or more relatively small, compact models that may be computationally less intensive compared to Vision Transformers.

Applications of segmentation masks generated from various techniques may be employed, which may be used for predicting fire spread, aiding in proactive firefighting measures, and performing damage assessments by evaluating the extent of damage to properties and natural resources. In various instances, segmentation masks may assist in monitoring environmental impacts, such as air quality degradation due to smoke and particulate matter from fires (see, e.g., Naser et al., 2020 and Attia et al., 2021).

As an example, a framework may utilize one or more techniques, which may include one or more CV techniques and/or ML techniques, to estimate gas flow rates from flare stacks. In such an example, a framework may be deployed for use with or without one or more flow meters. As an example, a framework may operate without use of one or more flow meters. In such an example, a framework may provide for monitoring and/or control without associated demands imposed by a flow meter.

As an example, a framework may provide for identifying one or more types of relationships. For example, consider operational and/or physical relationship, which may pertain to combustion, emissions, flow, etc. As an example, consider identification of a relatively linear dependency between flare size and amount of gas burnt in a flare stack. Building on such a relationship, a framework may implement a data-driven model that can take flare size as input with an ability to quantify gas flow rates and assess combustion efficiency. Such an approach may utilize one or more YOLO-based models, which may be relatively lightweight and thereby suitable for deployment using an edge device (e.g., an edge processor, etc.), which may improve upon alternative approach that can encounter computational limitations (e.g., as may be posed by Vision Transformers (ViTs)). To address a demand for labeled data, a framework may leverage the power of one or more foundational models capable of zero-shot predictions on new domains. As an example, by transferring knowledge from a larger foundational model to one or more YOLO-based models, a framework may be constructed in a manner that does not demand pre-labeled data. Such an approach can provide a substantial reduction in cost and effort associated with data labeling while maintaining relatively high segmentation accuracy. As an example, in certain instances, a few-shot approach may be implemented. For example, consider tailoring a YOLO type of model using data from a site to improve accuracy, etc. In such an example, a model may be improved at a site without having to provide substantial amounts of labeled data (e.g., samples). As an example, a few-shot approach may involve an amount of labeling that can be performed by a single human in a short period of time (e.g., within minutes), which may make it practical for implementation at a site or sites.

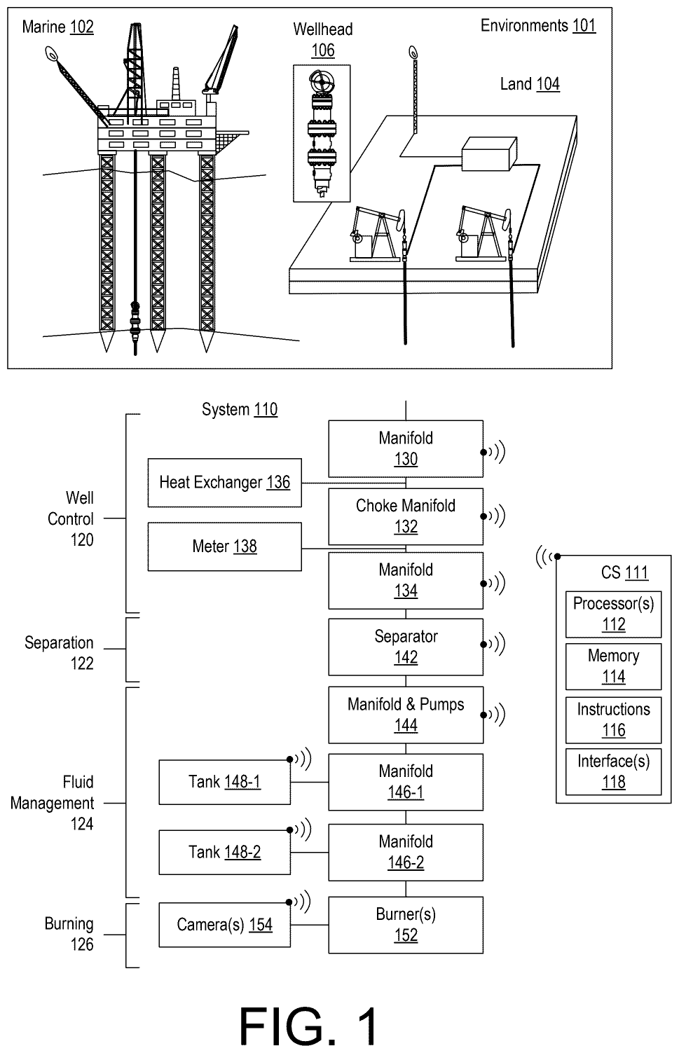

FIG. 1 shows examples of environments 101, including a marine environment 102 and a land environment 104 where the marine environment 102 includes various equipment and where the land environment 104 includes various equipment. As shown, each of the environments 101 can include one or more wellheads 106 (e.g., wellhead equipment). A wellhead can be a surface termination of a wellbore that can include a system of spools, valves and assorted adapters that, for example, can provide for pressure control of a production well. A wellhead may be at a land surface, a subsea surface (e.g., an ocean bottom, etc.), etc. As an example, conduits from multiple wellheads may be joined at one or more manifolds such that fluid from multiple wells can be flow in a common conduit.

At various times, a well may be tested using a process referred to as well testing. Well testing can include one or more of a variety of well testing operations. In various instances, fluid can flow from a well or wells to surface where the fluid is subjected to one or more well testing operations and generates scrap (e.g., waste fluid), which must be handled appropriately, for example, according to circumstances, regulations, etc. For example, consider loading waste fluid into a tanker for transport to a facility that can dispose of the waste fluid. Another manner of handling waste fluid can be through combustion, which can be referred to as burning. As an example, burning can be part of a well testing process, whether burning is for handling waste fluid and/or for analyzing one or more aspects of how one or more waste fluids burn. As to the latter, burning may optionally provide data as to one or more characteristics of well fluid (e.g., a component thereof, etc.).

As an example, disposal of produced hydrocarbons during one or more types of operations may be via burning, which can include on-site burning and/or off-site burning. Burning can be particularly suitable when facilities are not available for storage (e.g., consider mobile offshore drilling rigs, remote locations onshore, etc.).

As to the example environments 101 of FIG. 1, consider well testing as an operation that may be performed, for example, using equipment shown in the marine environment 102 and/or using equipment shown in the land environment 104. As an example, an environment may be under exploration, development, appraisal, etc., where such an environment includes at least one well where well fluid can be produced (e.g., via natural pressure, via fracturing, via artificial lift, via pumping, via flooding, etc.). In such an environment, various types of equipment may be on-site, which may be operatively coupled to well testing equipment.

FIG. 1 shows an example of a system 110 that can be operatively coupled to one or more conduits that can transport well fluid, for example, from one or more wellheads. As shown, the system 110 can include a computational system 111 (CS), which can include one or more processors 112, a memory 114 accessible to at least one of the one or more processors 112, instructions 116 that can be stored in the memory 114 and executable by at least one of the one or more processors 112, and one or more interfaces 118 (e.g., wired, wireless, etc.). In the example of FIG. 1, the system 110 is shown as including various communication symbols, which may be for transmission and/or reception of information (e.g., data, commands, etc.), for example, to and/or from the computational system 111. As an example, the computational system 111 can be a controller that can issue control instructions to one or more pieces of equipment in an environment such as, for example, the marine environment 102 and/or the land environment 104. As an example, the computational system 111 may be local, may be remote or may be distributed such that it is in part local and in part remote.

Referring again to the wellhead 106, it can include various types of wellhead equipment such as, for example, casing and tubing heads, a production tree, a blowout preventer, etc. Fluid produced from a well can be routed through the wellhead 106 and into the system 110, which can be configured with various features for well testing operations.

In the example of FIG. 1, the system 110 is shown to include various segments, which may be categorized operationally. For example, consider a well control segment 120, a separation segment 122, a fluid management segment 124, and a burning segment 126.

As shown in the example of FIG. 1, the well control segment 120 is an assembly of various components such as a manifold 130, a choke manifold 132, a manifold 134, a heat exchanger 136 and a meter 138; the separation segment 122 includes a separator 142; the fluid management segment 124 is an assembly of various components such as manifolds and pumps 144, a manifold 146-1, a manifold 146-2, a tank 148-1 and a tank 148-2; and the burning segment 126 includes a burner 152 and one or more cameras 154.

As mentioned, in the example of FIG. 1, the system 110 includes various features for one or more aspects of well testing operations; noting that the system 110 may include lesser features, more features, alternative features, etc. For example, consider one or more of a gas specific gravity meter, a water-cut meter, a gas-to-oil ratio sensor, a carbon dioxide sensor, a hydrogen sulfide sensor, or a shrinkage measurement device. Various features may be upstream and/or downstream of a separator segment or a separator.

With respect to flow of fluid from a well or wells, such fluid may be received by the well control segment 120 and then routed via one or more conduits to the separation segment 122. In the example of FIG. 1, the well control segment 120 the heat exchanger 136 may be provided as a steam-heat exchanger and the meter 138 for measuring flow of fluid through the well control segment 120.

As mentioned, the well control segment 120 can convey fluid received from one or more wells to the separator 142. As an example, the separator 142 can be a horizontal separator or a vertical separator, and can be a two-phase separator (e.g., for separating gas and liquids) or a three-phase separator (e.g., for separating gas, oil, and water). A separator may include various features for facilitating separation of components of incoming fluid (e.g., diffusers, mist extractors, vanes, baffles, precipitators, etc.).

As an example, fluid can be single phase or multiphase fluid where “phase” refers to an immiscible component (e.g., consider two or more of oil, water, and gas).

As an example, the separator 142 can be used to substantially separate multiphase fluid into its oil, gas, and water phases, as appropriate and as present, where each phase emerging from the separator 142 may be referred to as a separated fluid. Such separated fluids may be routed away from the separator 142 to the fluid management segment 124. In various instances, the separated fluids may not be entirely homogenous. For example, separated gas exiting the separator 142 can include some residual amount of water or oil and separated water exiting the separator 142 can include some amount of oil or entrained gas. Similarly, separated oil leaving the separator 142 can include some amount of water or entrained gas.

As shown in the example of FIG. 1, the fluid management segment 124 includes flow control equipment, such as various manifolds and pumps (generally represented by the block 144) for receiving fluids from the separator 142 and conveying the fluids to other destinations, as well as additional manifolds 146-1 and 146-2 for routing fluid to and from fluid tanks 148-1 and 148-2. While two manifolds 146-1 and 146-2 and two tanks 148-1 and 148-2 are depicted in FIG. 1, it is noted that the number of manifolds and tanks can be varied. For instance, in one embodiment, the fluid management segment 124 can include a single manifold and a single tank, while in other embodiments, the fluid management segment 124 can include more than two manifolds and more than two tanks.

As to the manifolds and pumps 144, they can include a variety of manifolds and pumps, such as a gas manifold, an oil manifold, an oil transfer pump, a water manifold, and a water transfer pump. In at least some embodiments, the manifolds and pumps 144 can be used to route fluids received from the separator 142 to one or more of the fluid tanks 148-1 and 148-2 via one or more of the additional manifolds 146-1 and 146-2, and to route fluids between the tanks 148-1 and 148-2. As an example, the manifolds and pumps 144 can include features for routing fluids received from the separator 142 directly to the one or more burners 152 for burning gas and oil (e.g., bypassing the tanks 148-1 and 148-2) or for routing fluids from one or more of the tanks 148-1 and 148-2 to the one or more burners 152.

As noted above, components of the system 110 may vary between different applications (e.g., operations, etc.). As an example, equipment within each functional group of the system 110 may also vary. For example, the heat exchanger 136 could be provided as part of the separation segment 122, rather than of the well control segment 120.

In certain embodiments, the system 110 can be a surface well testing system that can be monitored and controlled remotely. Remote monitoring may be effectuated with sensors installed on various components. In some instances, a monitoring system (e.g., sensors, communication systems, and human-machine interfaces) can enable monitoring of one or more of the segments 120, 122, 124, and 126. As shown in the example of FIG. 1, the one or more cameras 154 can be used to monitor one or more burning operations of the one or more burners 152, which may aim to facilitate control of such one or more burning operations at least in part through analysis of image data acquired by at least one of the one or more cameras 154.

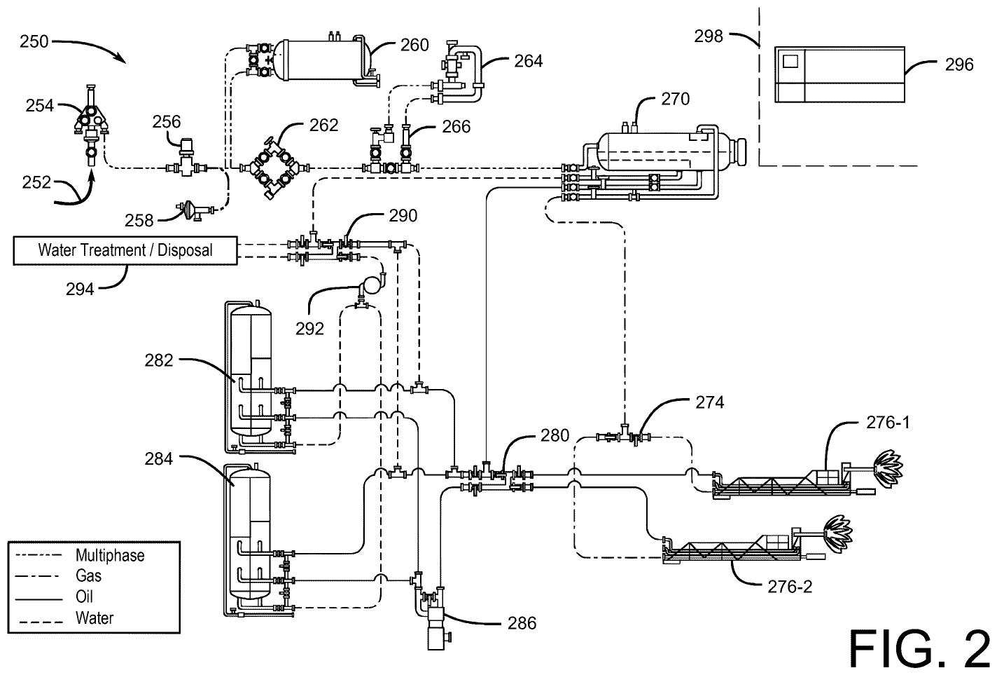

FIG. 2 shows an example of a system 250, which may be referred to as a surface well testing system. The system 250 can include various features of the system 110 of FIG. 1. Various equipment of the system 250, such as flaring equipment, may be present at one or more types of sites (e.g., production sites, well testing sites, etc.).

In FIG. 2, a multiphase fluid (represented here by arrow 252) enters a flowhead 254 and is routed to a separator 270 through a surface safety valve 256, a steam-heat exchanger 260, a choke manifold 262, a flow meter 264, and an additional manifold 266. In the example of FIG. 2, the system 250 includes a chemical injection pump 258 for injecting chemicals into the multiphase fluid flowing toward the separator 270.

In the depicted embodiment of FIG. 2, the separator 270 is a three-phase separator that generally separates the multiphase fluid 252 into gas, oil, and water components. The separated gas is routed downstream from the separator 270 through a gas manifold 274 to either of the burners 276-1 and 276-2 for flaring gas and burning oil. The gas manifold 274 includes valves that can be actuated to control flow of gas from the gas manifold 274 to one or the other of the burners 276-1 and 276-2. Although shown next to one another in FIG. 2 for sake of clarity, the burners 276-1 and 276-2 may be positioned apart from one another, such as on opposite sides of a rig, etc.

As shown, the separated oil from the separator 270 can be routed downstream to an oil manifold 280. Valves of the oil manifold 280 can be operated to permit flow of the oil to either of the burners 276-1 and 276-2 or either of the tanks 282 and 284. The tanks 282 and 284 can be of a suitable form, but are depicted in FIG. 2 as vertical surge tanks each having two fluid compartments. This allows each tank to simultaneously hold different fluids, such as water in one compartment and oil in the other compartment. An oil transfer pump 286 may be operated to pump oil through the well testing system 250 downstream of the separator 270. The separated water from the separator 270 can be similarly routed to a water manifold 290. Like the oil manifold 280, the water manifold 290 includes valves that can be opened or closed to permit water to flow to either of the tanks 282 and 284 or to a water treatment and disposal apparatus 294. A water transfer pump 292 may be used to pump the water through the system.

A well test area in which the well testing system 250 (or other embodiments of a well testing system) is installed may be classified as a hazardous area. In some embodiments, the well test area is classified as a Zone 1 hazardous area according to International Electrotechnical Commission (IEC) standard 60079-10-1:2015.

In the example of FIG. 2, a cabin 296 at a wellsite may include various types of equipment to acquire data from the well testing system 250. These acquired data may be used to monitor and control the well testing system 250. In at least some instances, the cabin 296 can be set apart from the well test area having the well testing system 250 in a non-hazardous area. This is represented by the dashed line 298 in FIG. 2, which generally serves as a demarcation between the hazardous area having the well testing system 250 and the non-hazardous area of the cabin 296.

The equipment of a system can be monitored during a process to verify proper operation and facilitate control of the process. Such monitoring can include taking numerous measurements, examples of which can include choke manifold temperature and pressures (upstream and downstream), heat exchanger temperature and pressure, separator temperature and pressures (static and differential), oil flow rate and volume from the separator, water flow rate and volume from the separator, and fluid levels in tanks of a system.

As an example, a mobile monitoring system may be provided. In such an example, monitoring of a process can be performed on a mobile device (e.g., a mobile device suitable for use in Zone 1 hazardous area, like the well test area). Various types of information may be automatically acquired by sensors and then presented to an operator via the mobile device. The mobile monitoring system may provide various functions, such as a sensor data display, video display, sensor or video information interpretation for quality-assurance and quality-control purposes, and a manual entry screen (e.g., for a digital tally book for recording measurements taken by the operator).

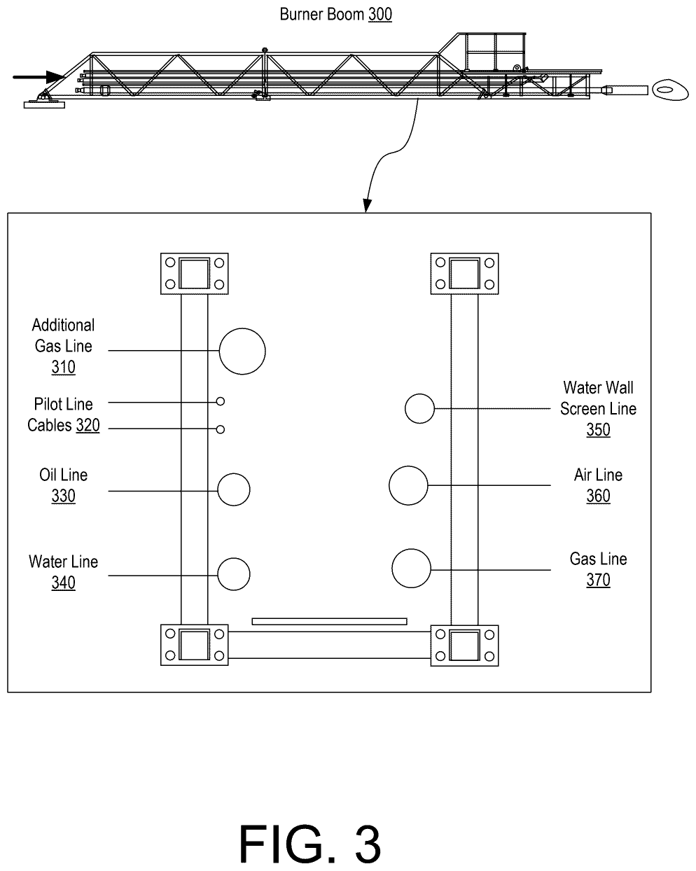

FIG. 3 shows an example of a burner boom 300, which can be configured for horizontal mounting, mounting at an angle, vertical mounting, etc. For example, the burner boom 300 can be mounted on a rig with a rotating base plate and guy lines. In such an example, horizontal guy lines can help to orient the burner boom 300; vertical guy lines, which are fixed to the rig's main structure, can support the burner boom 300. A rotating base can enable horizontal and vertical positioning of the burner boom 300 and its burner. As an example, the burner boom 300 may be positioned slightly above horizontal so that oil left in piping after flaring operations does not leak out. Flaring equipment such as the burner boom 300 may be present at one or more types of sites (e.g., production sites, well testing sites, etc.) to provide for flaring operations.

As an example, a burner can be boom mounted or mounted on another type of support structure. As an example, a structure can support various conduits that provide fluid such as, for example, one or more of air, water, oil, and propane.

In the example of FIG. 3, conduits or lines include an additional gas line 310, pilot line cables 320, an oil line 330, a water line 340, a water wall screen line 350, an air line 360, and a main gas line 370.

As to the burner boom 300 of FIG. 3, its burner can be configured and controlled to perform in a desirable manner. For example, it may be desired to burn in a fallout-free and smokeless manner for combustion of liquid hydrocarbons produced during well testing. As an example, a burner geometry can utilize pneumatic atomization and enhanced air induction. As an example, a burner can be equipped with one or more pilots, a flame-front ignition system (BRFI), and a built-in water screen to reduce heat radiation. As an example, a burner can be fitted with an automatic shutoff valve that prevents oil spillage at the beginning and end of a burning run.

As to burner control, a burner can include a high turn-down feature (e.g., 1:5), which may be optionally further extended to a higher ratio (e.g., 1:30) using a multirate kit (BMRK) option, which allows for selecting the number of operating nozzles. For onshore operations, a skid may be utilized for skid-mounting.

As to burner efficiency, a burner may be suited for high efficiency burning with one or more types of oil (e.g., including particularly heavy and waxy oils). As an example, a burner may operate effectively up to a water cut rating (e.g., up to 25 percent water cut), which may be desirable for various types of cleanup operations.

As a burner may be operational in a manner that provides for substantially no liquid fallout and substantially no visible smoke emissions, such a burner may be particularly suited for operations in environmentally sensitive areas. As an example, a burner may include one or more adjustable components, which may be adjustable via one or more controllers and/or manually. As an example, consider an adjustable nozzle that may be adjusted via a controller and/or manually (e.g., by hand, with a tool, etc.).

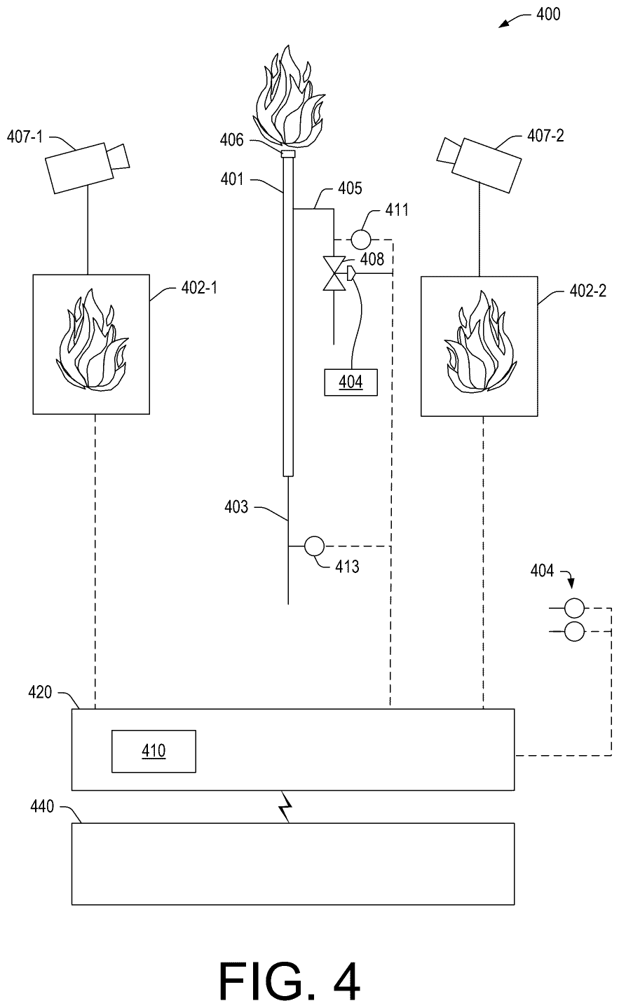

FIG. 4 is a system diagram of an example of a burner control system 400. The system 400 includes at least one camera 407-1 and 407-2 positioned to capture one or more images 402-1 and 402-2 of a flare emitted by a burner 401. In the example of FIG. 4, two cameras 407-1 and 407-2 are shown capturing images 402-1 and 402-2 from different locations to acquire image data from more than one image plane of the flare. The burner 401 includes a fuel feed 403 that flows fuel to the burner 401 (see, e.g., the burners 276-1 and 276-2 of FIG. 2, the burner 300 of FIG. 3, etc.). The burner 401 also includes an air feed 405 that flows air to the burner 401. Flow rate of the air feed 405 is controlled by a control valve 408, where an air flow sensor 411 senses flow rate of air into the burner 401. As an example, the burner 401 may include an adjustable nozzle 406. A fuel flow sensor 413 senses flow rate of fuel to the burner 401. Other sensors 404, along with the at least one camera 407-1 and 407-2, are operatively coupled to local electronic equipment 420. The sensors 404 may sense, and produce signals representing, combustion effective parameters such as temperature, wind speed, and ambient humidity. The sensors 404, 411, and 413, and the cameras 407-1 and 407-2 send data, including data representing the images 402-1 and 402-2, along with data representing readings of the sensors 404, 411, and 413, directly and/or indirectly, to the local electronic equipment 420, which may be present at a wellsite in a production phase, a drilling phase (e.g., in a doghouse, a cabin, etc.), a testing phase, etc. The data sent to the local electronic equipment 420 can represent a state of combustion taking place at the burner 401.

As shown in the example of FIG. 4, the local electronic equipment 420 can be in communication with remote electronic equipment 440. For example, consider use of one or more wired and/or wireless interfaces that allow for communications between the local and remote electronic equipment 420 and 440. In such an example, various computational tasks may be executed locally and/or remotely. For example, consider a local computing device that can include an application that can render a graphical user interface (GUI) to a display. In such an example, the GUI can include control graphics that are selectable to issue instructions such as, for example, one or more application programming interface (API) calls, which may be directed to the local electronic equipment 420, the remote electronic equipment 440, etc., to cause one or more actions to occur such as formulation of a response to an API call.

As an example, the local and remote electronic equipment 420 and 440 may be configured in a client-server arrangement where the local electronic equipment 420 operates as a client and the remote electronic equipment 440 operates as a server. As an example, data acquired by the local electronic equipment 420 (e.g., as part of the system 400) may be processed for local control and/or transmitted (e.g., as raw and/or processed data) for processing, storage, etc., by the remote electronic equipment 440. As an example, the remote electronic equipment 440 can include one or more cloud-based resources. In such an example, the remote electronic equipment 440 may provide services such as, for example, software as a service. As an example, control effectuated by the system 400 to control the burner 401 can be based on local and/or remote computing (e.g., using the local electronic equipment 420, the remote electronic equipment 440, etc.).

As to control of a burner, a model can be used, which may be a physics-based model, a machine learning model, a hybrid model, etc. As an example, a model-based approach can allow for prediction of various parameters such as, for example, air control parameters based on the data from the sensors 404, 411, and 413 and the at least one of the one or more cameras 407-1 and 407-2. As an example, one or more air control parameters can be applied to the control valve 408 to control air supply to the burner 401, which can be part of a combustion process that generates a flare that can be captured, as depicted in the one or more images 402-1 and 402-2. As mentioned, the burner 401 may include the adjustable nozzle 406, which may provide for control according to one or more parameters.

Camera as used herein, means an imaging device. A camera can capture an image of electromagnetic (EM) radiation in a medium that can be converted to data for use in digital processing. The conversion can take place within the camera or in a separate processor. The camera may capture images in one wavelength or across a spectrum (e.g., or spectra), which may encompass the ultraviolet (UV) spectrum, the visible spectrum, and/or the infrared spectrum. For example, a camera may capture an image of wavelengths from approximately 350 nm to approximately 1,500 nm. As an example, one or more of a broad spectrum imaging device such as a LIDAR detector, a narrower spectrum detector such as a charged-coupled device (CCD) array, and a short-wave infrared detector can be used as an imaging device or as imaging devices. Cameras can be monovision cameras or stereo cameras.

In the example of FIG. 4, the local electronic equipment 420 is shown as including an image processing unit 410, which may include and/or be operatively coupled to a model or models for purposes of processing one or more of the images 402-1 and 402-2 as captured by the at least one camera 407-1 and 407-2. As an example, a data set, along with sensor data representing oil flow rate, gas flow rate, water or steam flow rate, air flow rate, pressure, temperature, wind speed, ambient humidity, and other combustion effective parameters, can be considered different types of inputs. As an example, a model can receive input or inputs and can output one or more air control parameters, such as flow rate, pressure, and/or temperature, for the burner 401 (e.g., or burners) controlled by the system 400.

As to a machine learning model (ML model), such a model can be a neural network model (NN model). As an example, a trained ML model can be utilized to control one or more burners. As an example, a trained ML model can be trained with respect to a particular burner and/or type of burner. In such an approach, a trained ML model can be selected based at least in part on burner specifications (e.g., manufacturer, model, features, history, etc.).

Various types of data may be acquired and optionally stored, which may provide for training one or more ML models and/or for offline analysis, etc. For example, air control parameters output by a trained NN model can be stored in digital storage for later analysis, which may include further training, training a different ML model, etc. During control of an ongoing burning operation, one or more air control parameters can be transmitted to one or more control valves that control air supply to one or more burners as may be operatively coupled to the system controlled by the control system. Subsequent images and sensor data acquisitions can be captured, and the control cycle repeated as many times as desired. Frequency of repetition can depend on various time constants of the system 400. As an example, a cycle may be as short as a fraction of a second or as long as five to ten minutes. As an example, consider a 1 Hz operational frequency where several images are captured in a one second interval as in a video feed where computing air control parameters and applying the computed air control parameters to a control valve controlling air supply to the burner are based on the images in the one second interval. As an example, video may be live, with some amount of latency due to transmission and processing time, or video may be deliberately delayed by a delay amount.

As an example, the image processing unit 410 can convert signals derived from photons received by the one or more cameras 407-1 and 407-2 into data. The image processing unit 410 may be within or separate from a camera. As an example, the image processing unit 410 can convert signals received from the one or more cameras 407-1 and 407-2 into digital data representing photointensity in defined areas of the image and can assign position information to each digital data value. As an example, photointensity may be deconvolved into constituent wavelengths to produce a spectrum for each pixel. Such a spectrum may be sampled in defined bins, and the data from such sampling structured into a data set representing spectral intensity of the received image, for example, as a function of x-y position in the image. As an example, a timestamp can be added. For example, camera circuitry can include a digital clock and/or network circuitry that can receive a clock signal.

As an example, an image can be a pixel image with pixel position coordinate, a pixel depth and a timestamp. As to depth, various conventions may be utilized and depend on equipment and/or processing. Where color is utilized, a color depth can be referenced. For example, 8-bit color and 24-bit color can be the same where, in an RGB color space, 8-bits refers to each R, G, and B (e.g., subpixel), while 24-bit is a sum of the three 8-bit channels (e.g., 3×8=24). Standards can include, for example, monochrome (e.g., 1-bit) to 4K (e.g., 12-bit color, which provides 4096 colors), etc.

As to color models, RGB can be mapped to a cube. For example, a horizontal x-axis can be a red axis (R) for red values, a y-axis can be a blue axis (B) for blue values, and a z-axis can be a green axis (G) for green values. The origin, of such a cube (e.g., 0, 0, 0) can be black and an opposing point can be white (e.g., 1, 1, 1).

Another type of color model is the Y′UV model, which defines a color space in terms of one luma component (Y′) and two chrominance components, called U (blue projection) and V (red projection), respectively. The Y′UV color model is used in the PAL composite color video (excluding PAL-N) standard.

Yet another type of color model is the HSV color model. The RGB color model can define a color as percentages of red, green, and blue hues (e.g., as mixed together) while the HSV color model can define color with respect to hue (H), saturation(S), and value (V). For the HSV color model, as hue varies from 0 to 1.0, corresponding colors vary from red through yellow, green, cyan, blue, magenta, and back to red (e.g., red values exist at both at 0 and 1.0); as saturation varies from 0 to 1.0, corresponding colors (hues) vary from unsaturated (e.g., shades of gray) to fully saturated (e.g., no white component); and as value, or brightness, varies from 0 to 1.0, corresponding colors become increasingly brighter.

Saturation may be described as, for example, representing purity of a color where colors with the highest saturation may have the highest values (e.g., represented as white in terms of saturation) and where mixtures of colors are represented as shades of gray (e.g., cyans, greens, and yellow shades are mixtures of true colors). As an example, saturation may be described as representing the “colorfulness” of a stimulus relative to its own brightness; where “colorfulness” is an attribute of a visual sensation according to which the perceived color of an area appears to be more or less chromatic and where “brightness” is an attribute of a visual sensation according to which an area appears to emit more or less light.

As an example, a method for assessing imagery can include accessing one or more resources as to color models (e.g., as a plug-in, external executable code, etc.). For example, consider a method that includes instructions to access an algorithm of a package, a computing environment, etc., such as, for example, the MATLAB computing environment (marketed by MathWorks, Inc., Natick, MA). The MATLAB computing environment includes an image processing toolbox, for example, with algorithms for color space (e.g., color model) conversions, transforms, etc. As an example, the MATLAB computing environment includes functions “rgb2hsv” and “hsv2rgb” to convert images between the RGB and HSV color spaces (see, e.g., http://www.mathworks.com/help/images/converting-color-data-between-color-spaces.html).

Colors of a flame can depend on temperature of the flame and the material being burned. The colder part of a diffusion (incomplete combustion) flame tends to be red, transitioning to orange, yellow, and white as the temperature increases as evidenced by changes in the black-body radiation spectrum. A blue-colored flame can emerge when amount of soot decreases and blue emissions from excited molecular radicals become dominant. For example, the orange in a campfire depends on temperature and sodium in firewood while blue streaks can come from carbon and hydrogen in the firewood. In another example, the colors of stars can also indicate their temperatures. The closest star to Earth, the sun, has a surface temperature of approximately 5538° C. (10,000° F.). In general, red can be observed, for example, in a range of temperatures from approximately 525° C. (977° F.) to approximately 1000° C. (1,830° F.); orange can be observed in a range from approximately 1100° C. (2,010° F.) to approximately 1200° C. (2,190° F.) and white can be observed in a range from approximately 1300° C. (2,370° F.) to approximately 1500° C. (2,730° F.). As an example, a method or a system can include a smoke chart (e.g., consider a Ringelmann smoke chart, etc.), which may include different graduated maps. The Ringelmann system can include graduated shades of gray, for example, consider five equal steps between white and black. As explained, a site may include one or more types of monitoring and/or control systems for burner operations.

As an example, a system can be a multisite system. As an example, information acquired locally at one or more sites (e.g., camera data, processed camera data, operational data, etc.) may be utilized in combination with one or more types of satellite data and/or other data. For example, a method can include assessing satellite data (e.g., raw or processed) using information acquired locally at one or more sites. In such an example, data indicative of flaring in satellite data may be characterized using information acquired locally, which may characterize a satellite observed flare more specifically (e.g., as to chemical and/or spectral emissions, efficiency, etc.). In such an approach, satellite data can be enriched by locally acquired data, which may facilitate training of one or more ML models.

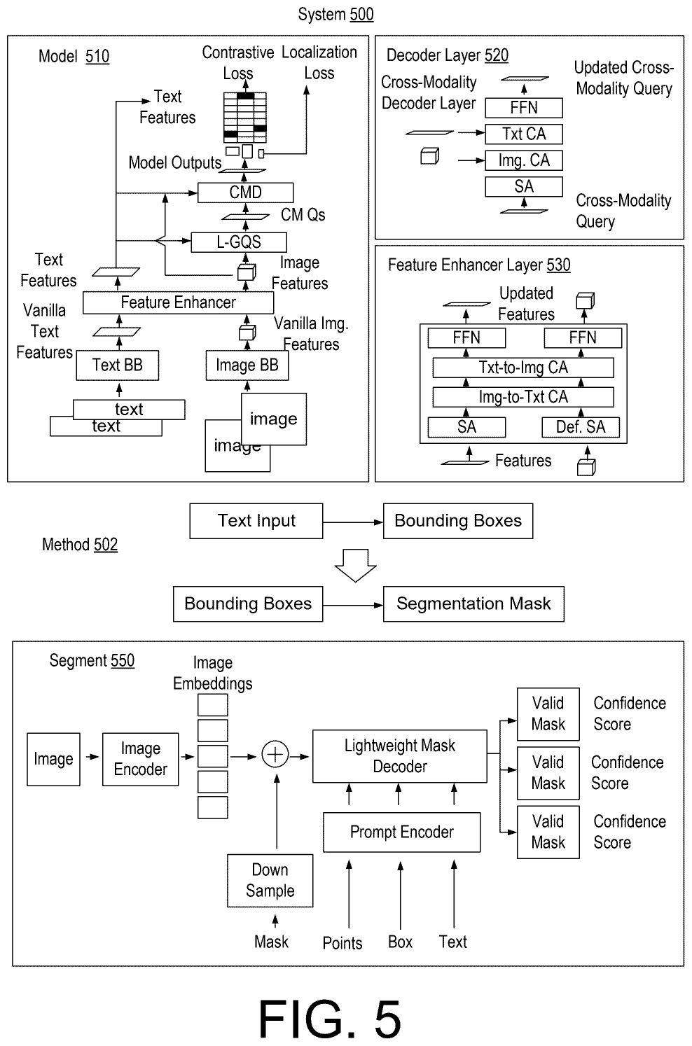

FIG. 5 shows an example of a system 500 along with examples of one or more workflows, which may be part of a method 502. As shown, the system 500 may include various framework components that provide for generation of and/or use of an ensemble foundational model. For example, consider a workflow that includes a first stage that involves a GroundingDino model, which uses a text prompt to detect and localize objects in an image and a second stage that involves a SegmentAnything model, which takes a bounding box from the first stage and segments a corresponding object, for example, in a manner that may not demand prior contextual information.

In the example of FIG. 5, the system 500 is shown with a model architecture 510, a decoder layer 520, a feature enhancer layer 530, and a segment architecture 550. As an example, the model architecture 510 and the layers 520, and 530 may be part of a first stage that involves a GroundingDino model and the segment architecture 550 may be part of a SegmentAnything model. As shown, the method 502 may provide for text to bounding boxes and then bounding boxes to a segmentation mask.

As to the model architecture 510, consider input text to a text backbone (BB) and input image(s) to an image backbone (BB) where the backbones (BBs) can extract vanilla text features and vanilla image features, respectively, which may be provided to a feature enhancer (see, e.g., the feature enhancer layer 530). As shown, the feature enhancer layer 530 can include self-attention (SA), deformable SA (Def. SA), image-to-text cross-attention (CA), text-to-image cross-attention (CA) and feed-forward networks (FFNs), such that updated text features and updated image features may be generated.

As shown, both text and image features may be fed to a language-guide query selection (L-GQS) component, which is operatively coupled to a cross-modality decoder (CMD) layer, for example, consider the decoder layer 530. As shown, the decoder layer can provide for input of a cross-modality query (e.g., image and text) fed to a self-attention (SA) component, an image cross-attention (CA) component together with image features and a text cross-attention (CA) component with text features, where output may be fed to an FFN to generate an updated cross-modality query. As shown, cross-modality queries (CM Qs) may be output by the language-guide query selection (L-GQS) component, where an updated cross-modality query is generated whereby model outputs may be processed for contrastive loss and localization loss, for example, the former assisted by text features. In the example of FIG. 5, a matrix is shown for text features and model outputs (e.g., image-related) such that an entry or entries can be generated.

As to the segment architecture 550, as shown, an image may be fed to an image encoder component to generate image embeddings where a mask can be fed to a down sample component that can be utilized with the image embeddings to feed a lightweight mask decoder, which may also be fed by output of a prompt encoder based on one or more of points, box(es), and text. As shown, the lightweight mask decoder can generate one or more valid masks with corresponding confidence scores.

As an example, a framework may provide for knowledge distillation from a foundational model. For example, consider a workflow that includes accessing a substantial amount of historical video footage of flare stacks. In such an example, to make this data usable, it may first be sampled with respect to frames corresponding to timestamps for which gas flow rate data are available, for example, as may be initially collected using one or more gas flow meters.

As explained, a sequence of a GroundingDino model and a SegmentAnything model may be implemented as part of a workflow, for example, by applying such a sequence to a substantial amount of unlabeled video data to generate a large segmentation dataset for fire from flare stacks. In a trial implementation, upon initial random inspection, the trial confirmed that operation of the GroundingDino model caused some bottlenecking, as it occasionally misidentified objects, such as mistaking clouds in the evening sky for fire when given the text query “Fire”. As to the SegmentAnything model, lacking contextual information, it appropriately segmented an object within a bounding box, however, at times, this resulted in inappropriate labels, for example, consider segments of clouds labeled as fire.

In a trial workflow, a relatively small model was trained on the noisy segmentation dataset. In this trial workflow, the smaller model, a student model, appropriately distilled knowledge from both foundational models. For example, given an image, the student model accurately localized and segmented “fire,” demonstrating that it had learned appropriate contextual information. Further, even when fed with incorrectly labeled training data (e.g., images with clouds labeled as “fire”), the student model appropriately detected and segmented only the fire. This trial success indicated that the trial workflow had trained a segmentation model from scratch with zero human-labeled data, achieving the intended context. In this trial, the student model achieved an mAP50 of 0.92, mAP50-95 of 0.96, precision of 0.91, and recall of 0.93.

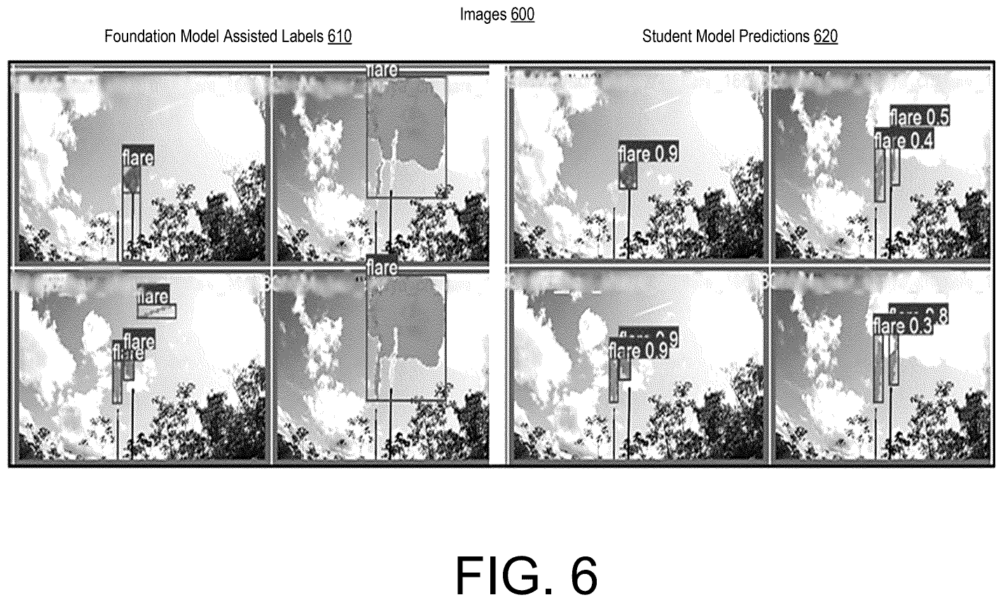

FIG. 6 shows example images 600 of samples from the aforementioned dataset. As shown, the left image grid 610 displays segmentation labels from the ensemble foundational model (ground-truth), while the right image grid 620 shows predictions from the student model. Visually, the ensemble model incorrectly segments clouds as flare in the top-right and bottom-right images, but the student model “corrects” this error, accurately segmenting the flare and excluding the clouds. In the bottom-left image, the ensemble model mislabels a jet exhaust as flare, which the student model correctly identifies as not flare. The student model effectively learned and rectified the “false positive” and “true negative” errors present in the dataset. As shown in the image 600 to the right, bounding boxes may be utilized to identify flares, which may be indicative of flare area and/or one or more other aspects of a flare, flaring equipment, etc. As an example, one or more YOLO types of models may be applied for purposes of segmentation and/or identification of one or more aspects of a flare, etc. In various instances, smoke may be a type of object identifiable by a model or models. As explained, in various instances, a few-shot approach may be practically implemented.

As an example, a framework may provide for implementation of a workflow that may include determining a relationship between flare size and gas flow rate. For example, consider an approach where one or more domain experts may observe that flare size changes with gas flow rate, which may be an initial supposition. In such an example, a workflow may include acquiring empirical evidence to develop this initial supposition into a hypothesis, which could then be modeled. To test this supposition, a workflow acquired video data over five days and gas flow rate data from gas flow meters for the same period. However, the gas flow rate data was not continuous; it was sporadic, covering a couple of hours each day. The gas flow rate data had a frequency of one data point every five seconds, which was resampled to one data point every two seconds to increase the total number of data points. In this trial, the video data had a frame rate of 25 FPS, which was down sampled to 1 FPS, which helped to allow for correlating the frames with the corresponding gas flow rate measurements.

Once this multimodal time-series data set was prepared, an inference run was performed using the trained student model. In this trial workflow, the student model segmented the flares in each of the frames, and using OpenCV utilities, where computations for properties for the segmentation mask were performed, for example, consider properties such as area, width, height, moments of the segment, and the angle of orientation of the flare. For initial tests, the area of the flare was utilized.

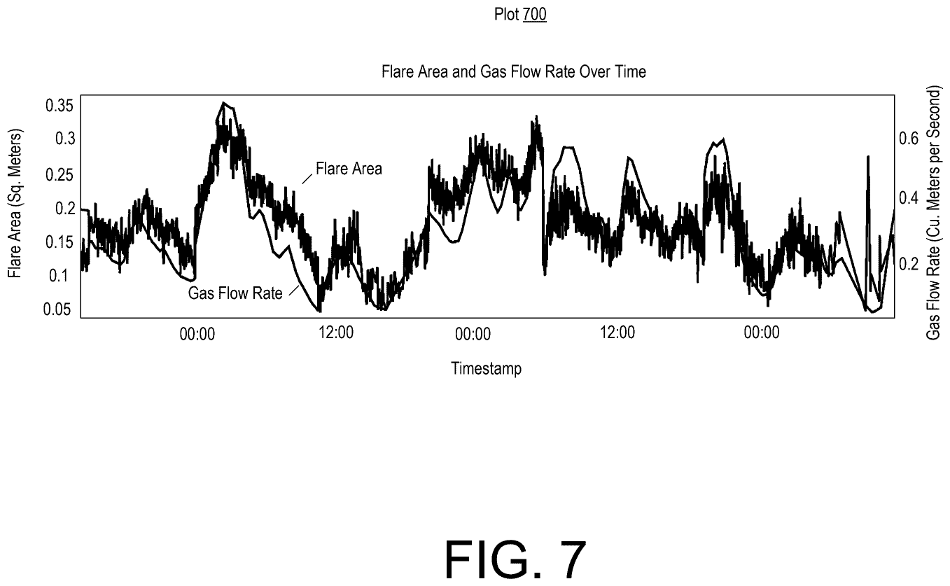

FIG. 7 shows an example plot 700 that illustrates the relationship between flare area and gas flow rate over the experimentation period. Due to the presence of external factors, correlation between flare area and gas flow rate varies, with some periods showing a high correlation and others a lower correlation. Specifically, correlation fluctuates due to external factors, resulting in periods of high and low correlation. Despite these fluctuations, the average correlation coefficient of 0.75 for the entire period indicates a moderate positive relationship between the two variables.

At first glance, while this might not seem like a relatively strong correlation, it nevertheless indicates a moderate positive correlation between flare area and gas flow rate. Environmental factors such as wind speed and ambient temperature may also affect the flare, which may, for example, be taken into account. As an example, accounting for various external factors might improve correlation between flare area and gas flow rate. However, as demonstrated, a basic approach was sufficient to prove the hypothesis and premise to a degree sufficient for training a statistical model to predict the gas flow rate based on the flare area. As an example, a framework may provide for receipt of additional data, which may include wind and/or other environmental data. In such an example, one or more rules may be generated that may be based at least in part on environmental data where, for example, such rule or rules may be applied to increase accuracy of model output. As an example, a framework may provide for control of equipment, which may be based on model output and/or one or more other factors.

As explained, a framework may provide for gas flow rate estimation. For example, given the student segmentation model and associated proven hypothesis, a workflow may include training a statistical model using flare area as an independent variable and gas flow rate as a dependent variable. For example, consider an approach that may utilize one or more of various regression models available in a machine learning framework such as the SCIKIT platform (e.g., scikit-learn framework or sklearn) where such one or more models may be trained and, for example, compared to identify a most effective model (or models) for estimating gas flow rate from flare area.

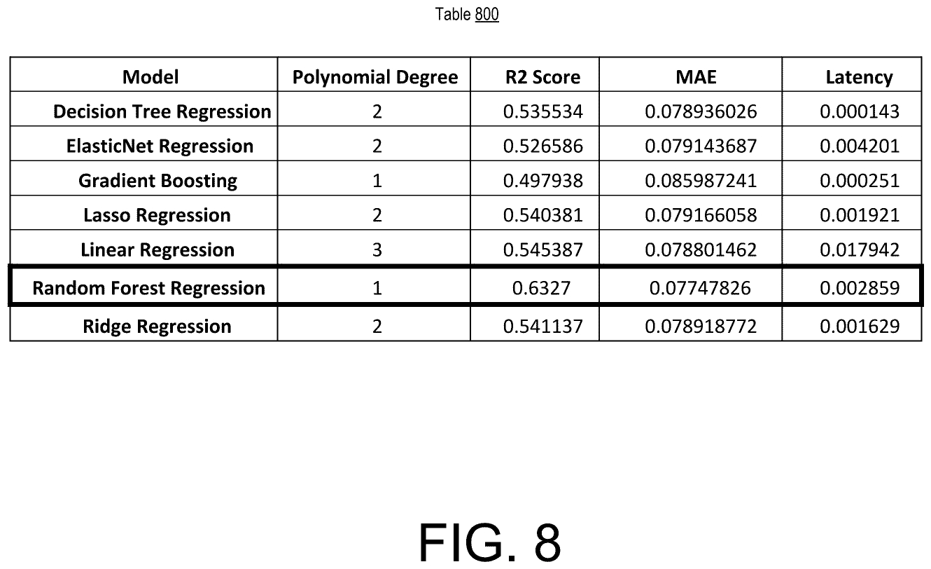

FIG. 8 shows an example table 800 that includes a listing of models and corresponding results. As shown, the models can include Decision Tree Regression, ElasticNet Regression, Gradient Boosting, Lasso Regression, Linear Regression, and Random Forest Regression. Such models may be assessed with respect to various metrics, which may include, for example, one or more of PolynomialDegree, R2 Score, MAE, and Latency.

Given the multimodal data set, which included video footage and gas-flow rate measurements, proper model training was ensured without shuffling the data as shuffling time series data could possibly disrupt the temporal patterns within these data. To address this possible issue, Group-K-Fold cross-validation was implemented with a group ID representing the video identifier associated with each frame. To enhance model robustness and reduce risks of learning anomalies, standard scaler normalization was applied. Upon a visual inspection, a polynomial relationship between gas flow rate and flare area prompt inclusion of polynomial features in various preprocessing steps.

In an example workflow, rather than manually comparing model results, a grid search with the following setup was implemented: (a) Model Selection and Hyperparameters: Several regression models were selected, each with a specific set of hyperparameters for tuning; (b) Pipeline Creation: A pipeline was created for each model, incorporating standard scaling and polynomial feature transformation; (c) Grid Search: grid search using GridSearchCV to determine the best hyperparameters for each model. The search evaluated models based on negative mean absolute error and R2 score, with the R2 score used to refit the best model; and (d) Cross-Validation: Group K-fold cross-validation helped to ensure that data from the same video did not appear in both training and test sets, preserving the integrity of the time series data.

Following grid the search, in a trial workflow, the RandomForestRegressor model was selected. As an ensemble model, Random Forest can provide for compensating for flaws and bottlenecks of individual estimators by combining their strengths. This characteristic may be an underlying reason the Random Forest model performed better than the other models that were tested. As shown in the table 800 of FIG. 8, the RandomForestRegressor ensemble model outperformed the individual best models, achieving an overall R2 score of 0.63 and a mean absolute error of 0.077 m³/s within the gas flow rate range of 0.327 to 1.307 m³/s. For various application, these metrics can be indicators of acceptable accuracy for measurement and reporting purposes.

As explained, a gas flow rate flaring framework can provide for estimating gas flow rates from flare stacks using CV and ML techniques. For example, a framework may leverage a YOLO-based segmentation model (e.g., or a few-shot model, etc.), which may help to pioneer a shift from costly gas flow meters to an AI-centric approach for estimating gas flow efficiency. Such an approach can address concerns associated with high installation and maintenance costs of meters, for example, by performing measurements through computational units such as, for example, edge devices, which may provide for substantial cost reduction. Additionally, unlike traditional meters that may have fixed measurement ranges, a regression model-based approach may adapt to varying conditions and provide for accurate estimations even outside an initial training range (e.g., within reasonable limits). Further, a model may be utilized to emulate scenarios with pressure drops, for example, estimating gas flow rates accurately even at lower pressure levels. As an example, calibration of a framework may be handled programmatically, making it simpler and more efficient than manual calibration. In various instances, flare stacks already have cameras and edge devices that may be amenable for seamless integration of one or more frameworks, framework components, etc.

In an example trial, approximately 48 hours of data over 5 days were utilized, resulting in around 65,000 images. Using the GroundingDino foundational model and the SegmentAnything foundational model, a workflow distilled knowledge from these images into a YOLO-based segmentation model. As explained, a model, trained on this data set, achieved relatively high-performance metrics, with an mAP50 of 0.92, mAP50-95 of 0.96, precision of 0.91, and recall of 0.93. These results indicate high segmentation accuracy, demonstrating the model's ability to correctly identify and segment fire regions even with noisy labels.

Through analysis of the segmented data, a moderate positive correlation between flare size and gas flow rate was observed (e.g., with an average correlation coefficient of approximately 0.75). Despite fluctuations due to external factors such as wind speed and ambient temperature, this correlation provided a sound basis for developing a statistical model to predict gas flow rates based on flare size.

As explained, to predict gas flow rates, several regression models were trained and evaluated. As explained, a RandomForestRegressor model may be suitable for making predictions, which may be estimates of gas flow rates. As explained, grid search and cross-validation processes may be applied for purposes of model evaluation, selection, etc. As explained, such processes revealed that the RandomForestRegressor achieved an R2 score of 0.63 and a mean absolute error (MAE) of 0.077 m³/s within the gas flow rate range of 0.327 to 1.307 m³/s.

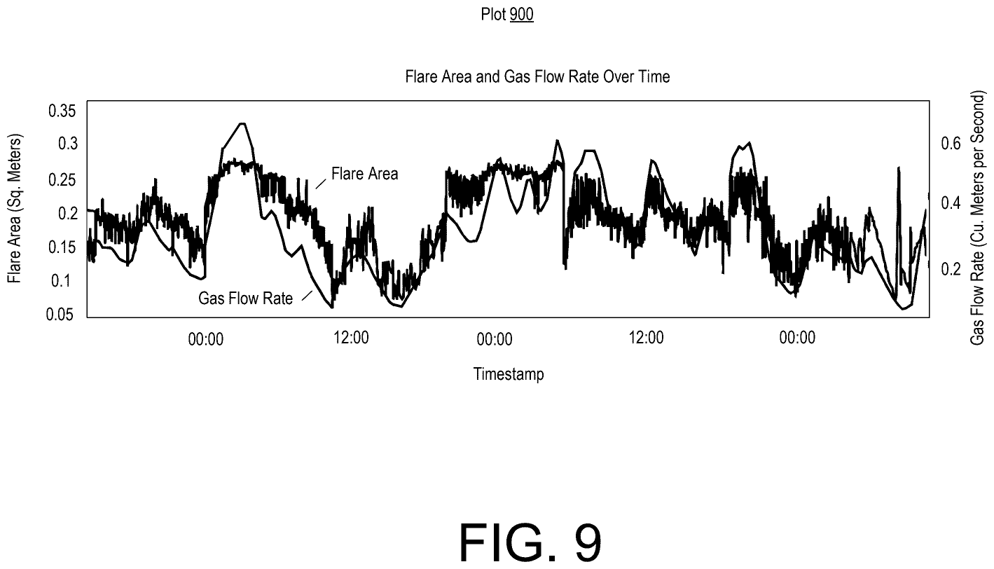

FIG. 9 shows an example plot 900 that illustrates the comparison between true gas flow rate and predicted gas flow rate over the experimentation period. As shown, a slight mismatch in the estimation of gas flow rate from the model is observed when the flare is affected by one or more external factors. The plot 900 demonstrates the model's ability to estimate the gas flow rate accurately from flare footage.

The results demonstrate that the model effectively estimates gas flow rates based on flare size. As explained, such an approach can offer a cost-effective and efficient alternative to use of gas flow meters. Such an approach can, for example, enhance transparency of flare stack operations and/or help to ensure compliance with environmental regulations.

Calculations of combustion efficiency of a flare stack from gas flow rate may also be available, for example, for monitoring emissions, control, reporting to pollution control boards and government bodies, etc.

In a trial workflow, a segmentation model, optimized for an INTEL ATOM-powered edge hardware device, was able to analyze approximately 10 frames per second, averaging predictions over minute-long intervals for cloud-based operational oversight. Comparative field trials against physical meters at operational flare stack sites have validated the model's low mean absolute error (MAE), reinforcing its precision. Results advocate for a progressive reduction in dependency on conventional gas flow meters, with the vision that future iterations of an AI workflow may supplant them. In instances where meter replacement is not feasible, an AI system (e.g., gas flow rate flaring framework) may be implemented in a manner that may complement existing infrastructure, for example, in a manner that can provide valuable insights that may be beyond capabilities of traditional meters.

As explained, a framework may be developed to provide suitable precision of AI-driven estimates, which may in various instances be contingent at least in part upon correlation strength between one or more dependent and one or more independent variables.

As mentioned, smoke may be a factor in flaring and/or one or more other scenarios. As an example, a framework may provide for black smoke opacity detection, for example, leveraging Zero-Shot Knowledge Transfer from one or more foundational models (e.g., akin to those implemented for flare segmentation), noting that a YOLO-World model may be implemented as a type of zero-shot model. As an example, a framework may provide for integration of black smoke detection with flare segmentation. In such an example, the framework may enhance an ability to quantify emissions, control emissions, etc., and/or deepen insights into environmental impact. Such a combined approach may offer more comprehensive solutions for environmental monitoring, control, and regulatory compliance.

As explained, at oil and gas extraction sites, gas flares can be utilized used for a variety of purposes such as one or more of startup, maintenance, testing, safety, and emergency purposes noting that production flaring at a site may be used to dispose of amounts of unwanted associated gas, possibly throughout the life of a well. Gas flares as utilized in one or more industries may be assessed and, for example, classified. A gas flare may be known as a flare stack, a flare boom, a ground flare, or a flare pit where gas combustion equipment of an industrial plant (e.g., a petroleum refinery, a chemical plant, a natural gas processing plant, etc.) controls the gas flare through a gas flaring process. As explained, different types of gas flares can exhibit different characteristics, which may pertain to size, emissions, efficiency, scheduling, etc. As an example, a method can include assessing one or more types of gas flares as to their characteristics, which may provide for determinations as to intended behavior, unintended behavior, etc.

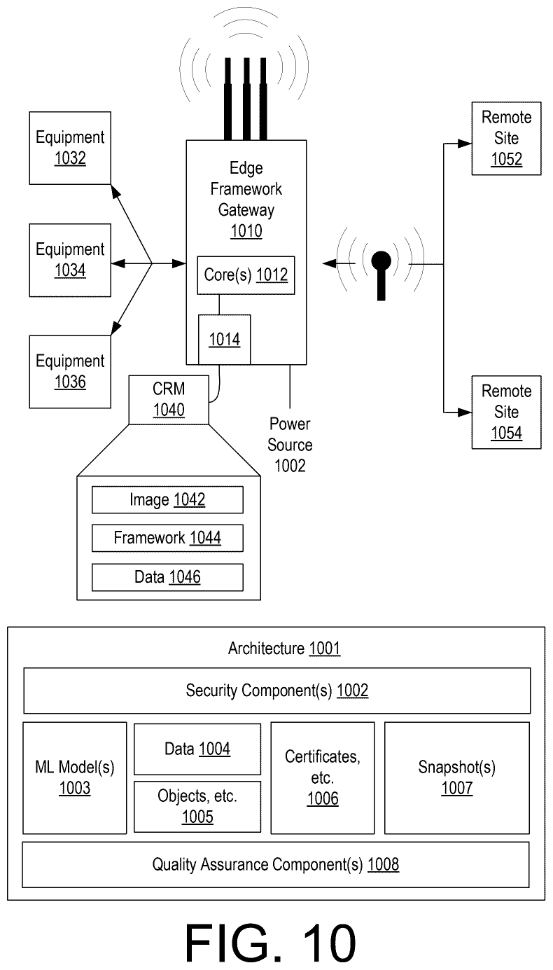

FIG. 10 shows an example of a system 1000 and an example of an architecture 1001. As shown, the architecture 1001 can provide for one or more security components 1002, one or more machine learning models 1003, data 1004, objects, etc. 1005, certificates, etc. 1006, snapshots, etc. 1007, and one or more quality assurance components 1008. As an example, a quality assurance component may be associated with one or more types of implementation strategies. For example, consider a field device that may receive instructions as to how to implement a deployed machine learning model, etc.

The architecture 1001 can include a result interface where an output result can be a control trigger that can call for an action or actions by a piece or pieces of equipment.

As shown, the system 1000 can include a power source 1002 (e.g., solar, generator, batter, grid, etc.) that can provide power to an edge framework gateway 1010 that can include one or more computing cores 1012 and one or more media interfaces 1014 that can, for example, receive a computer-readable medium 1040 that may include one or more data structures such as an image 1042, a framework 1044 and data 1046. In such an example, the image 1042 may be an operating system image that can cause one or more of the one or more cores 1012 to establish an operating system environment that is suitable for execution of one or more applications. For example, the framework 1044 may be an application suitable for execution in an established operating system in the edge framework gateway 1010.

In the example of FIG. 10, the edge framework gateway 1010 (“EF”) can include one or more types of interfaces suitable for receipt and/or transmission of information. For example, consider one or more wireless interfaces that may provide for local communications at a site such as to one or more pieces of local equipment 1032, 1034 and 1036 and/or remote communications to one or more remote sites 1052 and 1054.

As an example, the EF 1010 may be installed at a site that is some distance from a city, a town, etc. In such an example, the EF 1010 may be accessible via a satellite communication network and/or one or more networks.

A communications satellite is an artificial satellite that relays and amplifies radio telecommunication signals via a transponder. A satellite communication network can include one or more communication satellites that may, for example, provide for one or more communication channels. As of 2021, there are about 2,000 communications satellites in Earth orbit, some of which are geostationary above the equator such that a satellite dish antenna of a ground station can be aimed permanently at a satellite rather than tracking the satellite.

High frequency radio waves used for telecommunications links travel by line-of-sight, which may be obstructed by the curve of the Earth. Communications satellites can relay signal around the curve of the Earth allowing communication between widely separated geographical points. Communications satellites can use one or more frequencies (e.g., radio, microwave, etc.), where bands may be regulated and allocated.

Satellite communication tends to be slower and more costly than other types of electronic communication due to factors such as distance, equipment, deployment and maintenance. For wellsites that do not have other forms of communication, satellite communication can be limiting in one or more aspects. For example, where a controller is to operate in real-time or near real-time, a cloud-based approach to control may introduce too much latency.

As shown in the example of FIG. 10, the EF 1010 may be deployed where it can operate locally with one or more pieces of equipment 1032, 1034, 1036, etc., which may be for purposes of control, monitoring, reporting, etc. As an example, the EF 1010 may include switching and/or communication capabilities, for example, for information transmission between equipment, etc.

As desired, from time to time, communication may occur between the EF 1010 and one or more remote sites 1052, 1054, etc., which may be via satellite communication where latency and costs are tolerable. As an example, the CRM 1040 may be a removable drive that can be brought to a site via one or more modes of transport. For example, consider an air drop, a human via helicopter, plane or boat, etc.

As to an air drop, consider dropping an electronic device that can be activated locally once on the ground or while being suspended by a parachute en route to ground. Such an electronic device may communicate via a local communication system such as, for example, a local WiFi, BLUETOOTH, cellular, etc., communication system. In such an example, one or more data structures may be transferred from the electronic device (e.g., as including a CRM) to the EF 1010. Such an approach can provide for local control where one or more humans may or may not be present at the site. As an example, an autonomous and/or human controllable vehicle at a site may help to locate an electronic device and help to download its payload to an EF such as the EF 1010. For example, consider a local drone or land vehicle that can locate an air dropped electronic device and retrieve it and transfer one or more data structures from the electronic device to an EF, directly and/or indirectly. In such an example, the drone or land vehicle may establish communication with and/or read data from the electronic device such that data can be communicated (e.g., transferred to one or more EFs).

As shown in FIG. 10, an EF may execute within a gateway such as, for example, an AGORA gateway (e.g., consider one or more processors, memory, etc., which may be deployed as a “box” that can be locally powered and that can communicate locally with other equipment via one or more interfaces). As an example, one or more pieces of equipment may include computational resources that can be akin to those of an AGORA gateway or more or less than those of an AGORA gateway. As an example, an AGORA gateway may be a network device.

As an example, a gateway can include one or more features of an AGORA gateway (e.g., v.202, v.402, etc.) and/or another gateway. For example, consider an INTEL ATOM E3930 or E3950 Dual Core with DRAM and an eMMC and/or SSD. Such a gateway may include a trusted platform module (TPM), which can provide for secure and measured boot support (e.g., via hashes, etc.). A gateway may include one or more interfaces (e.g., Ethernet, RS485/422, RS232, etc.). As to power, a gateway may consume less than about 100 W (e.g., consider less than 10 W or less than 20 W). As an example, a gateway may include an operating system (e.g., consider LINUX DEBIAN LTS). As an example, a gateway may include a cellular interface (e.g., 4G LTE with Global Modem/GPS, etc.). As an example, a gateway may include a WIFI interface (e.g., 802.11 a/b/g/n). As an example, a gateway may be operable using AC 100-240 V, 50/60 Hz or 24 VDC. As to dimensions, consider a gateway that has a protective box with dimensions of approximately 10 in×8 in×4 in (e.g., 25 cm×20.3 cm×10.1 cm).

As an example, a gateway may be part of a drone. For example, consider a mobile gateway that can take off and land where it may land to operatively couple with equipment to thereby provide for control of such equipment. In such an example, the equipment may include a landing pad. For example, a drone may be directed to a landing pad where it can interact with equipment to control the equipment. As an example, a wellhead can include a landing pad where the wellhead can include one or more sensors (e.g., temperature and pressure) and where a mobile gateway can include features for generating fluid flow values using information from the one or more sensors. In such an example, the mobile gateway may issue one or more control instructions (e.g., to a choke valve, a pump, etc.).

As an example, a gateway may include hardware (e.g. circuitry) that can provide for operation of a drone. As an example, a gateway may be a drone controller and a controller for other equipment where the drone controller can position the gateway (e.g., via drone flight features, etc.) such that the gateway can control the other equipment.

As to types of machine learning models, consider one or more of a support vector machine (SVM) model, a k-nearest neighbors (KNN) model, an ensemble classifier model, a neural network (NN) model, etc. As an example, a machine learning model can be a deep learning model (e.g., deep Boltzmann machine, deep belief network, convolutional neural network, stacked auto-encoder, etc.), an ensemble model (e.g., random forest, gradient boosting machine, bootstrapped aggregation, AdaBoost, stacked generalization, gradient boosted regression tree, etc.), a neural network model (e.g., radial basis function network, perceptron, back-propagation, Hopfield network, etc.), a regularization model (e.g., ridge regression, least absolute shrinkage and selection operator, elastic net, least angle regression), a rule system model (e.g., cubist, one rule, zero rule, repeated incremental pruning to produce error reduction), a regression model (e.g., linear regression, ordinary least squares regression, stepwise regression, multivariate adaptive regression splines, locally estimated scatterplot smoothing, logistic regression, etc.), a Bayesian model (e.g., naïve Bayes, average on-dependence estimators, Bayesian belief network, Gaussian naïve Bayes, multinomial naïve Bayes, Bayesian network), a decision tree model (e.g., classification and regression tree, iterative dichotomiser 3, C4.5, C5.0, chi-squared automatic interaction detection, decision stump, conditional decision tree, M5), a dimensionality reduction model (e.g., principal component analysis, partial least squares regression, Sammon mapping, multidimensional scaling, projection pursuit, principal component regression, partial least squares discriminant analysis, mixture discriminant analysis, quadratic discriminant analysis, regularized discriminant analysis, flexible discriminant analysis, linear discriminant analysis, etc.), an instance model (e.g., k-nearest neighbor, learning vector quantization, self-organizing map, locally weighted learning, etc.), a clustering model (e.g., k-means, k-medians, expectation maximization, hierarchical clustering, etc.), etc.

As an example, the TENSORFLOW framework (Google LLC, Mountain View, California) may be implemented, which is an open source software library for dataflow programming that includes a symbolic math library, which can be implemented for machine learning applications that can include neural networks. As an example, the CAFFE framework may be implemented, which is a DL framework developed by Berkeley AI Research (BAIR) (University of California, Berkeley, California). As another example, consider the SCIKIT platform (e.g., scikit-learn), which utilizes the PYTHON programming language. As an example, a framework such as the APOLLO AI framework may be utilized (APOLLO.AI GmbH, Germany). As mentioned, a framework such as the PYTORCH framework may be utilized.

As an example, a training method can include various actions that can operate on a dataset to train a ML model. As an example, a dataset can be split into training data and test data where test data can provide for evaluation. A method can include cross-validation of parameters and best parameters, which can be provided for model training.

The TENSORFLOW framework can run on multiple CPUs and GPUs (with optional CUDA (NVIDIA Corp., Santa Clara, California) and SYCL (The Khronos Group Inc., Beaverton, Oregon) extensions for general-purpose computing on graphics processing units (GPUs)). TENSORFLOW is available on 64-bit LINUX, MACOS (Apple Inc., Cupertino, California), WINDOWS (Microsoft Corp., Redmond, Washington), and mobile computing platforms including ANDROID (Google LLC, Mountain View, California) and IOS (Apple Inc.) operating system based platforms.

TENSORFLOW computations can be expressed as stateful dataflow graphs; noting that the name TENSORFLOW derives from the operations that such neural networks perform on multidimensional data arrays. Such arrays can be referred to as “tensors”.

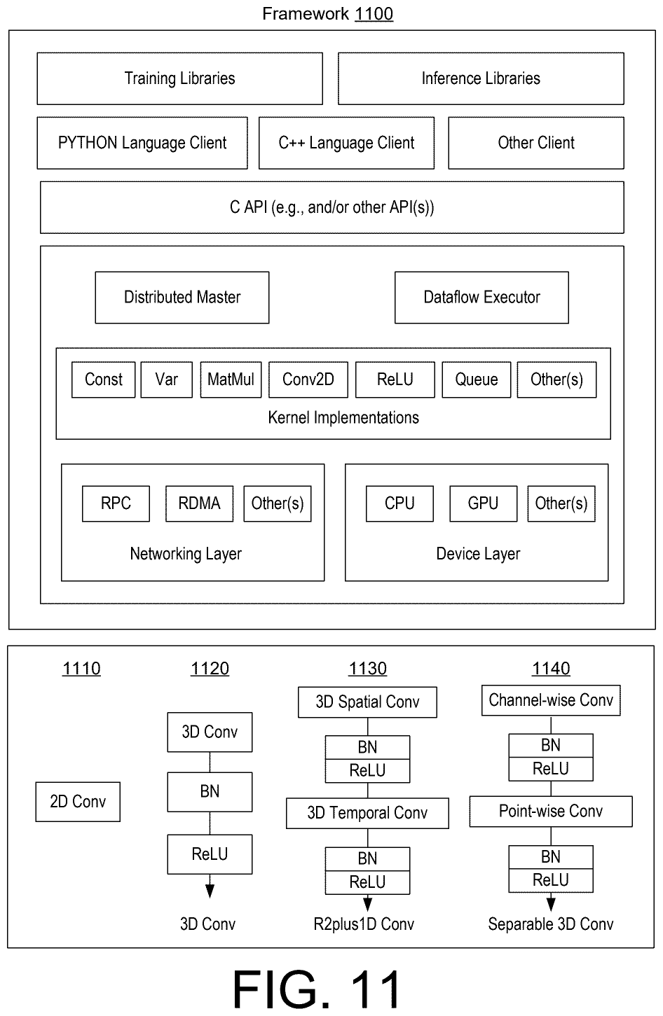

FIG. 11 shows an architecture 1100 of a framework such as the TENSORFLOW framework. As shown, the architecture 1100 includes various features. As an example, in the terminology of the architecture 1100, a client can define a computation as a dataflow graph and, for example, can initiate graph execution using a session. As an example, a distributed master can prune a specific subgraph from the graph, as defined by the arguments to “Session.run( )”; partition the subgraph into multiple pieces that run in different processes and devices; distributes the graph pieces to worker services; and initiate graph piece execution by worker services. As to worker services (e.g., one per task), as an example, they may schedule the execution of graph operations using kernel implementations appropriate to hardware available (CPUs, GPUs, etc.) and, for example, send and receive operation results to and from other worker services. As to kernel implementations, these may, for example, perform computations for individual graph operations.

FIG. 11 also shows some examples of types of machine learning models 1110, 1120, 1130, and 1140, one or more of which may be utilized. As explained, a ML model-based approach can include receiving image data that can be spatial image data. As an example, time can be a dimension such that image data can be spatial and temporal. As an example, a convolution neural network and/or one or more other types of neural networks can be utilized for spatial and/or spatial-temporal image analysis.

As an example, a ML model can address video (spatial-temporal image data) as sequences of short (e.g., N-frame) clips. In such an approach, various aspects of changes with respect to time may be related to one or more types of physical phenomena associated with flaring hydrocarbons, which, once analyzed, can be utilized for burner control. In such an example, framerate and number of frames in a sequence (e.g., a series) may cover a desired amount of time, which can be for tracking dynamic behavior of one or more burner operations. As an example, analyses may be performed using different sequences, using different number of frames, using different framerates, using different processing techniques as to raw frame data, using different frame resolutions, etc. Such variables may be tailored to provide for processing efficiency, which may help to provide for real-time monitoring, analysis, control, etc.

As an example, a system may monitor, analyze, control, etc., one or more operations in a basin region such as, for example, an onshore and/or an offshore region. For example, consider the Permian Basin, where gas production can exceed pipeline capacity exiting the Permian Basin region, which may result in increased flaring. The Permian Basin is predominantly a shale oil play and has large quantities of associated gas production. Permian crude and natural gas liquids (NGL) production are expected to grow from 3.3 MMb/d in 2017 to 8.8 MMb/d by 2025, which in turn is expected to cause natural gas production to rise from 7.1 to 16.0 bcfd over the same time frame.

As an example, a system can provide for monitoring flares at wellsites and production facilities to reduce their carbon footprint, comply with regulations, control site equipment, etc.

As an example, a system may receive one or more types of data that include satellite data. As an example, one or more types of data can include aircraft data (e.g., drone, plane, etc.) and/or land/sea vessel data.

A published international application entitled “Unlit flare detection using satellite images”, and having Serial Number PCT/US2022/018491, published as WO 2022187341 A1 on 9 Sep. 2022, is incorporated by reference herein in its entirety.

A published international application entitled “Adjustable Flare Tip”, and having Serial Number PCT/US2023/085292, published as WO 2024137906 A1 on 27 Jun. 2024, is incorporated by reference herein in its entirety.

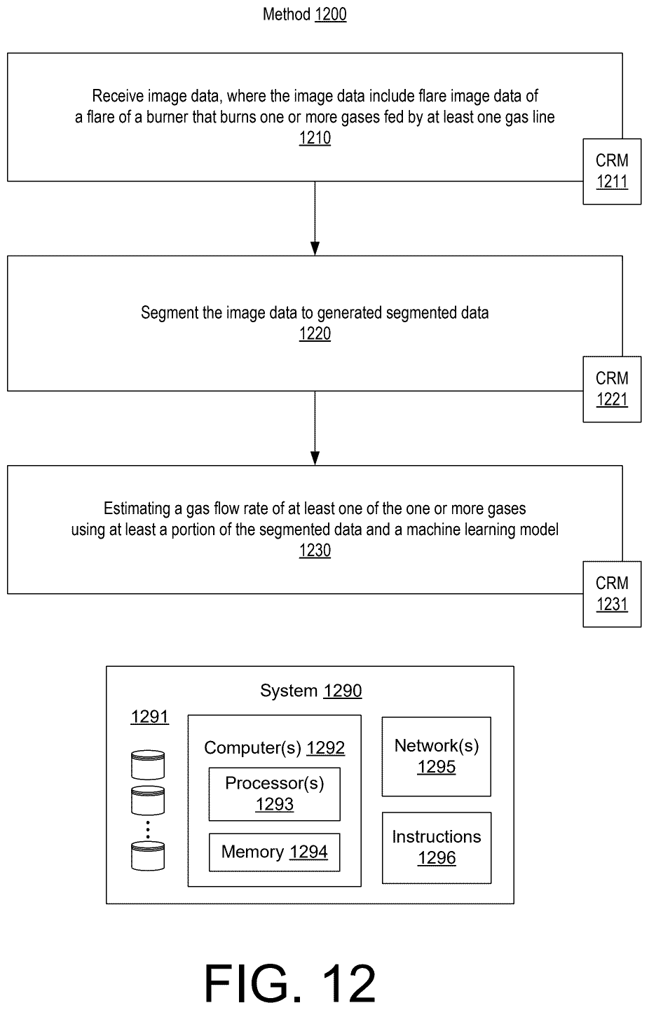

FIG. 12 shows an example of a method 1200 and an example of a system 1290. As shown, the method 1200 includes a reception block 1210 for receiving image data, where the image data include flare image data of a flare of a burner that burns one or more gases fed by at least one gas line; a segmentation block 1220 for segmenting the image data to generated segmented data; and an estimation block 1230 for estimating a gas flow rate of at least one of the one or more gases using at least a portion of the segmented data and a machine learning model.

The method 1200 is shown as including various computer-readable storage medium (CRM) blocks 1211, 1221, and 1231 that can include processor-executable instructions that can instruct a computing system, which can be a control system, to perform one or more of the actions described with respect to the method 1200.

In the example of FIG. 12, the system 1290 includes one or more information storage devices 1291, one or more computers 1292, one or more networks 1295 and instructions 1296. As to the one or more computers 1292, each computer may include one or more processors (e.g., or processing cores) 1293 and a memory 1294 for storing the instructions 1296, for example, executable by at least one of the one or more processors 1293 (see, e.g., the blocks 1211, 1221 and 1231). As an example, a computer may include one or more network interfaces (e.g., wired or wireless), one or more graphics cards, a display interface (e.g., wired or wireless), etc.

As an example, the method 1200 may be a workflow that can be implemented using one or more frameworks that may be within a framework environment. As an example, the system 1290 can include local and/or remote resources. For example, consider a browser application executing on a client device as being a local resource with respect to a user of the browser application and a cloud-based computing device as being a remote resources with respect to the user. In such an example, the user may interact with the client device via the browser application where information is transmitted to the cloud-based computing device (or devices) and where information may be received in response and rendered to a display operatively coupled to the client device (e.g., via services, APIs, etc.).

As an example, a method can include receiving image data, where the image data include flare image data of a flare of a burner that burns one or more gases fed by at least one gas line; segmenting the image data to generated segmented data; and estimating a gas flow rate of at least one of the one or more gases using at least a portion of the segmented data and a machine learning model. In such an example, the method may include controlling the burner based at least in part on the gas flow rate and/or one or more portions of the segmented data (e.g., directly and/or indirectly). In such an example, controlling may provide for flow rate control, composition control, timing as to on/off control, adjustable tip control, etc.

As an example, a machine learning model can be or include a regression model. As an example, a machine learning model can be an ensemble model. As an example, a machine learning model can be or include a forest model.

As an example, segmented data may indicate flare area of a flare. In such an example, a machine learning model may include flare area of the flare as an input.

As an example, segmenting may include implementing an object detection model. For example, consider an object detection model that is or includes a you only look once (YOLO) model.

As an example, a method may include performing receiving, segmenting, and estimating using equipment at a wellsite. For example, consider equipment that may include a camera and an edge device that includes a processor and memory. As an example, a method may include estimating that has a latency less than one minute with respect to receiving image data. As explained, a framework may provide for relatively rapid image segmentation and flow rate estimation.

As an example, one or more gasses fed to a burner may include methane gas and/or air. As an example, a method may include controlling a burner based at least in part on an estimated gas flow rate. In such an example, consider controlling air flow of the burner.

As an example, a method may include training a segmentation model to generate a trained segmentation model for implementation by a method that includes segmenting. In such an example, the method may include accessing historical image data and processing the historical image data using one or more foundational models.

As an example, a method may include segmenting that includes segmenting image data for smoke and segmenting image data for fire. In such an example, the method may include, based at least in part on the gas flow rate, optimizing a burner to adjust one or more characteristic of the smoke (e.g., smoke reduction, smoke color, smoke transparency and/or opacity, etc.).

As an example, a system can include a processor; a memory accessible by the processor; and processor-executable instructions stored in the memory that are executable to instruct the system to: receive image data, where the image data include flare image data of a flare of a burner that burns one or more gases fed by at least one gas line; segment the image data to generated segmented data; and estimate a gas flow rate of at least one of the one or more gases using at least a portion of the segmented data and a machine learning model.

As an example, one or more non-transitory computer-readable storage media can include computer-executable instructions executable to instruct a computer to: receive image data, where the image data include flare image data of a flare of a burner that burns one or more gases fed by at least one gas line; segment the image data to generated segmented data; and estimate a gas flow rate of at least one of the one or more gases using at least a portion of the segmented data and a machine learning model.

As an example, data can include data indicative of smoke generated by one or more flaring operations. For example, one or more types of sensors may provide indications of smoke, which may be an indicator of a poor quality burn (poor quality combustion). In such an example, a method can include issuing one or more signals such as a control signal to adjust combustion at a site (e.g., to improve burn quality).

A computer-readable storage medium (or computer-readable storage media) is non-transitory, not a signal and not a carrier wave. Rather, a computer-readable storage medium is a physical device that can be considered to be circuitry or hardware.

In an embodiment, a computer program product is provided that includes computer-executable instructions to instruct a computing system to perform the method 1200 or one or more other methods described herein.

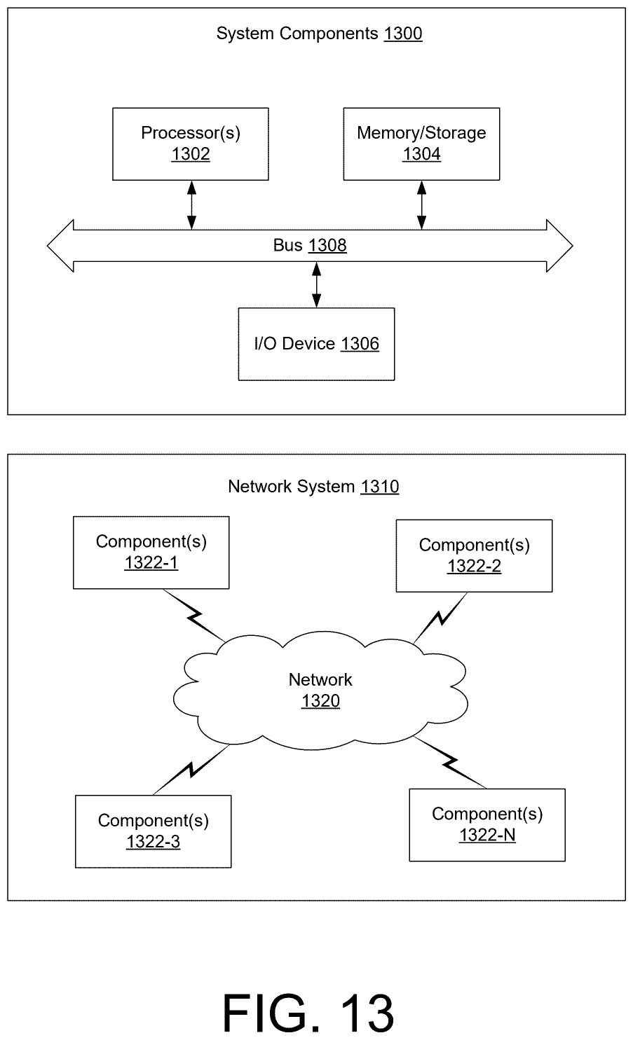

FIG. 13 shows components of an example of a computing system 1300 and an example of a networked system 1310 with a network 1320. The system 1300 includes one or more processors 1302, memory and/or storage components 1304, one or more input and/or output devices 1306 and a bus 1308. In an example embodiment, instructions may be stored in one or more computer-readable media (e.g., memory/storage components 1304). Such instructions may be read by one or more processors (e.g., the processor(s) 1302) via a communication bus (e.g., the bus 1308), which may be wired or wireless. The one or more processors may execute such instructions to implement (wholly or in part) one or more attributes (e.g., as part of a method). A user may view output from and interact with a process via an I/O device (e.g., the device 1306). In an example embodiment, a computer-readable medium may be a storage component such as a physical memory storage device, for example, a chip, a chip on a package, a memory card, etc. (e.g., a computer-readable storage medium).

In an example embodiment, components may be distributed, such as in the network system 1310. The network system 1310 includes components 1322-1, 1322-2, 1322-3, . . . 1322-N. For example, the components 1322-1 may include the processor(s) 1302 while the component(s) 1322-3 may include memory accessible by the processor(s) 1302. Further, the component(s) 1322-2 may include an I/O device for display and optionally interaction with a method. The network may be or include the Internet, an intranet, a cellular network, a satellite network, etc.

As an example, a device may be a mobile device that includes one or more network interfaces for communication of information. For example, a mobile device may include a wireless network interface (e.g., operable via IEEE 802.11, ETSI GSM, BLUETOOTH, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

As an example, information may be input from a display (e.g., consider a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that can be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

### BIBLIOGRAPHY (DOCUMENTS INCORPORATED BY REFERENCE HEREIN)

Reza Azin, Najmeh Mehrabi, Shahriar Osfouri, Masoud Asgari, An Overview of CCS Road Map and Identification of a Suitable CO₂ Disposal Site in Eastern Zagros (Fars Area) in Iran, Procedia Earth and Planetary Science, Volume 15, 2015, Pages 407-412.
Flaring Monitor. (2023). Estimating Flared Natural Gas Volumes Using Satellite Sensor Data. Retrieved from (https://www.flaringmonitor.org).
The World Bank, Flared gas utilization strategy opportunities for small-scale uses of gas. International Bank for Reconstruction and Development, Washington, DC (https://documents1.worldbank.org/curated/en/193801468779650307/pdf/295520Fla red0G1on0Strategy01public1.pdf).
Ronneberger, O., Fischer, P., Brox, T. (2015). U-Net: Convolutional Networks for Biomedical Image Segmentation. In: Navab, N., Hornegger, J., Wells, W., Frangi, A. (eds) Medical Image Computing and Computer-Assisted Intervention-MICCAI 2015. MICCAI 2015. Lecture Notes in Computer Science ( ) vol 9351. Springer, Cham. https://doi.org/10.1007/978-3-319-24574-4_28.
J. Long, E. Shelhamer and T. Darrell, “Fully convolutional networks for semantic segmentation,” in 2015 IEEE Conference on Computer Vision and Pattern Recognition (CVPR), Boston, MA, USA, 2015, pp. 3431-3440, doi: 10.1109/CVPR.2015.7298965.
Marto, T., Bernardino, A., Cruz, G. (2023). Fire and Smoke Segmentation Using Active Learning Methods. Remote Sensing, 15 (17), 4136. (https://doi.org/10.3390/rs15174136).
Naser, M. Z., Seitllari, A. (2020). Concrete under fire: an assessment through intelligent pattern recognition. Engineering with Computers, 36, 1915-1928. (https://doi.org/10.1007/s00366-020-01005-6).
Attia, R., et al. (2021). Wildfire Segmentation Using Deep Vision Transformers. Remote Sensing, 13 (17), 3527. (https://doi.org/10.3390/rs13173527).
Wang, F., Zhou, H., & Lin, H. (2024). Fire in Focus: Advancing Wildfire Image Segmentation by Focusing on Fire Edges. Forests, 15 (1), 217. (https://doi.org/10.3390/f15010217).
Talaat, F. M., ZainEldin, H. An improved fire detection approach based on YOLO-v8 for smart cities. Neural Comput & Applic 35, 20939-20954 (2023).
Alexander Kirillov, Eric Mintun, Nikhila Ravi, Hanzi Mao, Chloe Rolland, Laura Gustafson, Tete Xiao, Spencer Whitehead, Alex Berg, Wan-Yen Lo, Piotr Dollar, Ross Girshick. (2023). Segment Anything Model (SAM). GitHub. (https://github.com/facebookresearch/segment-anything).
Viso. (2024). Segment Anything Model (SAM)—The Complete 2024 Guide. Retrieved from (https://viso.ai).
Z. Liu et al., “Swin Transformer: Hierarchical Vision Transformer using Shifted Windows,” 2021 IEEE/CVF International Conference on Computer Vision (ICCV), Montreal, QC, Canada, 2021, pp. 9992-10002, doi: 10.1109/ICCV48922.2021.00986.
I. Arel, D. C. Rose and T. P. Karnowski, “Deep Machine Learning-A New Frontier in Artificial Intelligence Research [Research Frontier],” in IEEE Computational Intelligence Magazine, vol. 5, no. 4, pp. 13-18, November 2010, doi: 10.1109/MCI.2010.938364.
Goodfellow, I., Bengio, Y., & Courville, A. (2016). Deep Learning. MIT Press. (https://www.deeplearningbook.org).
Dietterich, T. G. (2000). Ensemble Methods in Machine Learning. In: Multiple Classifier Systems. MCS 2000. Lecture Notes in Computer Science, vol 1857. Springer, Berlin, Heidelberg. https://doi.org/10.1007/3-540-45014-9_1.
Gomez et al., Unlit flare detection using satellite images, Serial Number PCT/US2022/018491, published as WO 2022187341 A1 on 9 Sep. 2022.
Trifol, H., Adjustable Flare Tip, Serial Number PCT/US2023/085292, published as WO 2024137906 A1 on 27 Jun. 2024.

What is claimed is:

1. A method comprising:
receiving image data, wherein the image data comprise flare image data of a flare of a burner that burns one or more gases fed by at least one gas line;
segmenting the image data to generated segmented data; and
estimating a gas flow rate of at least one of the one or more gases using at least a portion of the segmented data and a machine learning model.

2. The method of claim 1, wherein the machine learning model comprises a regression model.

3. The method of claim 1, wherein the machine learning model comprises an ensemble model.

4. The method of claim 1, wherein the segmented data indicate flare area of the flare.

5. The method of claim 4, wherein the machine learning model comprises flare area of the flare as an input.

6. The method of claim 1, wherein the segmenting comprises implementing an object detection model.

7. The method of claim 6, wherein the object detection model comprises a you only look once (YOLO) model.

8. The method of claim 1, comprising performing the receiving, segmenting, and estimating using equipment at a wellsite.

9. The method of claim 8, wherein the equipment comprises a camera and an edge device that comprises a processor and memory.

10. The method of claim 9, wherein the estimating comprises a latency less than one minute with respect to the receiving.

11. The method of claim 1, wherein the one or more gasses comprise methane gas.

12. The method of claim 11, wherein the one or more gasses comprise air.

13. The method of claim 1, comprising controlling the burner based at least in part on the gas flow rate.

14. The method of claim 13, wherein the controlling comprises controlling air flow of the burner.

15. The method of claim 1, comprising training a segmentation model to generate a trained segmentation model for implementation by the segmenting.

16. The method of claim 15, comprising accessing historical image data and processing the historical image data using one or more foundational models.

17. The method of claim 1, wherein the segmenting comprises segmenting for smoke and segmenting for fire.

18. The method of claim 17, comprising, based at least in part on the gas flow rate, optimizing the burner to adjust one or more characteristic of the smoke.

19. A system comprising:
a processor;
a memory accessible by the processor; and
processor-executable instructions stored in the memory that are executable to instruct the system to:
receive image data, wherein the image data comprise flare image data of a flare of a burner that burns one or more gases fed by at least one gas line;
segment the image data to generated segmented data; and
estimate a gas flow rate of at least one of the one or more gases using at least a portion of the segmented data and a machine learning model.

20. One or more non-transitory computer-readable storage media comprising computer-executable instructions executable to instruct a computer to:
receive image data, wherein the image data comprise flare image data of a flare of a burner that burns one or more gases fed by at least one gas line;
segment the image data to generated segmented data; and
estimate a gas flow rate of at least one of the one or more gases using at least a portion of the segmented data and a machine learning model.
